(19) United States
(12) Patent Application Publication
(10) Pub. No.: US 2018/0184107 A1
(43) Pub. Date: Jun. 28, 2018

(54) MOTION ESTIMATION METHOD AND MOTION ESTIMATION APPARATUS

(71) Applicant: Novatek Microelectronics Corp., Hsinchu (TW)

(72) Inventors: Pengyuan Hu, Xi'an (CN); Xi Tian, Xi'an (CN); Yen-Sung Chen, New Taipei City (TW); Yuan-Jia Du, Shandong Province (CN)

(73) Assignee: Novatek Microelectronics Corp., Hsinchu (TW)

(21) Appl. No.: 15/674,522

(22) Filed: Aug. 11, 2017

Related U.S. Application Data
(63) Continuation-in-part of application No. 15/391,864, filed on Dec. 28, 2016.

(30) Foreign Application Priority Data
Aug. 2, 2017 (CN) 201710650632.6

(51) Int. Cl. H04N 19/513

(52) U.S. Cl. CPC H04N 19/513; H04N 19/176

(57) ABSTRACT

The invention provides an apparatus and a method for motion estimation. The motion estimation apparatus includes a candidate set generation circuit and a motion vector (MV) determination circuit. The candidate set generation circuit selects to add motion vectors of adjacent blocks into a motion vector candidate set of a current block of a current frame. The current block and one of the adjacent blocks belong to the same row (or the same column), and the one of the adjacent blocks is a block of the current frame or a block of a previous frame. The motion vector determination circuit is coupled to the candidate set generation circuit to receive the motion vector candidate set. The motion vector determination circuit determines the motion vector of the current block of the current frame according to the motion vector candidate set.

### CROSS-REFERENCE TO RELATED APPLICATION

This application is a continuation-in-part application of and claims the priority benefit of a prior application Ser. No. 15/391,864, filed on Dec. 28, 2016, now pending and China application serial no. 201710650632.6, filed on Aug. 2, 2017. The entirety of each of the above-mentioned patent applications is hereby incorporated by reference herein and made a part of specification.

### BACKGROUND

### Field of the Invention

The present invention relates to a motion estimation method and a motion estimator, and more particularly, to a motion estimation method and a motion estimator suitable for parallel processing.

### Description of Related Art

Motion estimation is an important technique in frame rate up conversion (FRC). Motion estimation refers to a process of finding a best or second best motion vector (MV). Generally, an image frame may be divided into a plurality of blocks. A motion vector may indicate a motion direction and a motion distance of a block. Generally, neighboring frames exhibit a strong correlation with each other in time and space, and usually have portions that are similar or identical to each. The related art presents a three dimension recursive search (3DRS) block matcher with two spatial candidate motion vectors set to the best motion vector of an upper left and an upper right adjacent blocks of a current block, where a convergence direction or a search direction corresponding thereto is from left to right and from up to down.

Please refer to FIG. 1, which is a schematic diagram of a candidate set of the conventional 3DRS motion estimation. The conventional 3DRS motion estimation method calculates a motion vector of a current block B0 in a current frame by using the motion vectors of a candidate set. As shown in FIG. 1, a block B0 of a current frame has the candidate set including a spatial candidate motion vector Sa of an upper left block 104 of the current block B0 in the current frame, a spatial candidate motion vector Sb of an upper right block 106 of the current block B0 in the current frame, a temporal candidate motion vector Ta of a block 108 in a previous frame, a temporal candidate motion vector Tb of a block 110 in the previous frame and a temporal candidate motion vector T0 of a block 102 in the previous frame. Note that the block 102 of the previous frame locates at the same position as the block B0 in the current frame. The blocks 102, 108 and 110 of the previous frame and the blocks 104 and 106 of the current frame have respective motion estimation processes done before. The motion vectors Sa and Sb are called spatial motion vectors since the blocks 104 and 106 locate in the same frame as the block B0, while the motion vectors T0, Ta and Tb are called temporal motion vectors because their associating blocks locate in the previous frame.

FIG. 2 schematically illustrates the forward motion estimation algorithm and the backward motion estimation algorithm. Referring to both FIG. 1 and FIG. 2, the motion vectors Sa and Sb are obtained from respective motion estimation processes of the associating blocks of the current frame F with a reference frame. According to design and application requirements, the reference frame may be a past frame (e.g. the frame F−1) in a backward motion estimation or a future frame (e.g. the frame F+1) in a forward motion estimation. The backward motion estimation obtains a motion vector mvb, and the forward motion estimation obtains a motion vector mvf. Similarly, the motion vectors T0, Ta and Tb are obtained from respective motion estimation of their associating blocks in the past frame F−1 with a reference frame F−2 (backward motion estimation) or a reference frame F (forward motion estimation).

FIG. 3 shows motion vector candidate set of the conventional 3DRS motion estimation. Beside the motion vectors from the blocks of the frames F and F−1 as shown in FIG. 1, the motion vector candidates of the block B0 may further include big random displacement and little random displacement of the spatial motion vectors Sa and Sb, and further include a zero motion vector or a global motion vector (GMV).

Candidate spatial motion vectors are from the blocks that are not at a same row or a same column of the current block B0. This would impose difficulty on parallel processing among rows or columns. Since motion estimation process for the current block B0 cannot be started until the blocks associated with the candidate spatial motion vectors (i.e. the blocks 104, 106) finish motion estimation and obtain respective motion vectors, Sa and Sb. Since candidate motion vectors particularly spatial motion vectors are from blocks apart from the current block B0, this could substantially decrease the convergence rate in obtaining an accurate motion vector for the current block B0. For complex movement in one picture, the conventional 3DRS technique of the related art leads to low convergence rate and wrong predicted displacement vector.

### SUMMARY

The invention provides an apparatus and a method for motion estimation with a faster convergence speed and predicted motion vectors with better accuracy.

According to an exemplary embodiment of the invention, a motion estimation method for estimating motion vectors of blocks of a current frame is provided. The method includes: selecting to add motion vectors of a plurality of adjacent blocks into a motion vector candidate set of a current block of the current frame, wherein the current block and one of the adjacent blocks belong to the same row or the same column, and the one of the adjacent blocks is a block of the current frame or a block of a previous frame; and determining a motion vector of the current block of the current frame according to the motion vector candidate set.

According to an exemplary embodiment of the invention, a motion estimation apparatus for estimating motion vectors of blocks of a current frame is provided. The motion estimation apparatus includes a candidate set generation circuit and a motion vector determination circuit. The candidate set generation circuit is configured to select to add motion vectors of a plurality of adjacent blocks into a motion vector candidate set of a current block of the current frame. The current block and one of the adjacent blocks belong to the same row or the same column, and the one of the adjacent blocks is a block of the current frame or a block of a previous frame. The motion vector determination circuit is coupled to the candidate set generation circuit to receive the motion vector candidate set. The motion vector determination circuit is configured to determine a motion vector of the current block of the current frame according to the motion vector candidate set.

According to an exemplary embodiment of the invention, a motion estimation method for estimating motion vectors of blocks of a current frame is provided. The method includes: selecting to add a motion vector of a current block of a previous frame into a motion vector candidate set of the current block of the current frame; and determining a motion vector of the current block of the current frame according to the motion vector candidate set.

According to an exemplary embodiment of the invention, a motion estimation apparatus for estimating motion vectors of blocks of a current frame is provided. The motion estimation apparatus includes a candidate set generation circuit and a motion vector determination circuit. The candidate set generation circuit is configured to select to add a motion vector of a current block of a previous frame into a motion vector candidate set of the current block of the current frame. The motion vector determination circuit is coupled to the candidate set generation circuit to receive the motion vector candidate set. The motion vector determination circuit is configured to determine a motion vector of the current block of the current frame according to the motion vector candidate set.

To sum up, the motion vector candidate sets introduced by the apparatus and the method for motion estimation of the exemplary embodiments of the invention are different from the motion vector candidate sets used in the 3DRS technique of the related art, such that the motion estimation apparatus of the invention has a faster convergence speed and predicted motion vectors with better accuracy.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a candidate set of the conventional three dimension recursive search (3DRS) motion estimation.

FIG. 2 schematically illustrates the forward motion estimation algorithm and the backward motion estimation algorithm.

FIG. 3 shows motion vector candidate set of the conventional 3DRS motion estimation.

FIG. 4 is a schematic diagram of a motion estimator according to an exemplary embodiment of the invention.

FIG. 5 is a schematic diagram of a procedure according to an exemplary embodiment of the invention.

FIG. 6 shows a motion vector candidate set of a block of a current frame in accordance with an exemplary embodiment of the invention.

FIGS. 7 to 10 are schematic diagrams of the candidate set according to exemplary embodiments of the invention.

FIG. 11 shows a case of a candidate set of a current block, a searching direction SD thereof and a processing sequence from top to bottom and left to right according to the direction SD.

FIG. 12 shows a case which applies parallel processing among rows while the 4^{th} row leads the others.

FIGS. 13 to 16 are schematic diagrams representing the search directions according to exemplary embodiments of the invention.

FIG. 17 is a schematic diagram representing the shifted block corresponding to the current block and the motion vector of the spatial candidate block according to an exemplary embodiment of the invention.

FIG. 18 is a schematic circuit block showing a motion estimation apparatus according to another exemplary embodiment of the invention.

FIG. 19 is a flowchart of a motion estimation method according to another exemplary embodiment of the invention.

FIG. 20 shows a motion vector candidate set of a current block of a current frame in accordance with an exemplary embodiment of the invention.

FIG. 21 shows sources of the candidate set CS according to an exemplary embodiment of the invention.

FIG. 22 is a flowchart of a motion estimation method according to yet another exemplary embodiment of the invention.

FIG. 23 is a schematic diagram showing a parallel processing flow of the motion estimation method according to yet another exemplary embodiment of the invention.

FIG. 24 is a schematic diagram showing the processing of frame rate up conversion (FRC) according to an exemplary embodiment of the invention.

FIG. 25 is a flowchart of a motion estimation method according to another exemplary embodiment of the invention.

FIG. 26 shows an example for the projected ME process.

FIG. 27 shows another example for the projected motion estimation process.

FIG. 28 shows that a forward motion vector and a backward motion vector are selected as candidate motion vectors.

FIG. 29 exemplarily illustrates that a possible candidate set CS of a current block may include a plurality of temporal motion vectors from more than one adjacent frames at the same block position of the current block in addition to the spatial and temporal motion vectors from adjacent blocks of the current and previous frames as shown in FIG. 20.

FIG. 30 shows a possible candidate set CS for a forward motion estimation process.

FIG. 31 shows a possible candidate set CS for a backward motion estimation process.

FIG. 32 shows sources of the candidate set CS according to another exemplary embodiment.

FIG. 33 is a schematic diagram of the processing of a candidate set according to yet another exemplary embodiment.

FIG. 34 is a schematic circuit block diagram showing the motion estimation apparatus depicted in FIG. 18 according to an exemplary embodiment of the invention.

FIG. 35 is a schematic circuit block diagram showing the motion estimation apparatus depicted in FIG. 18 according to another exemplary embodiment of the invention.

FIGS. 36 to 41 show a portion of the candidate sets of FIG. 35, respectively.

FIG. 42 is a flowchart showing a motion estimation method according to yet another exemplary embodiment of the invention.

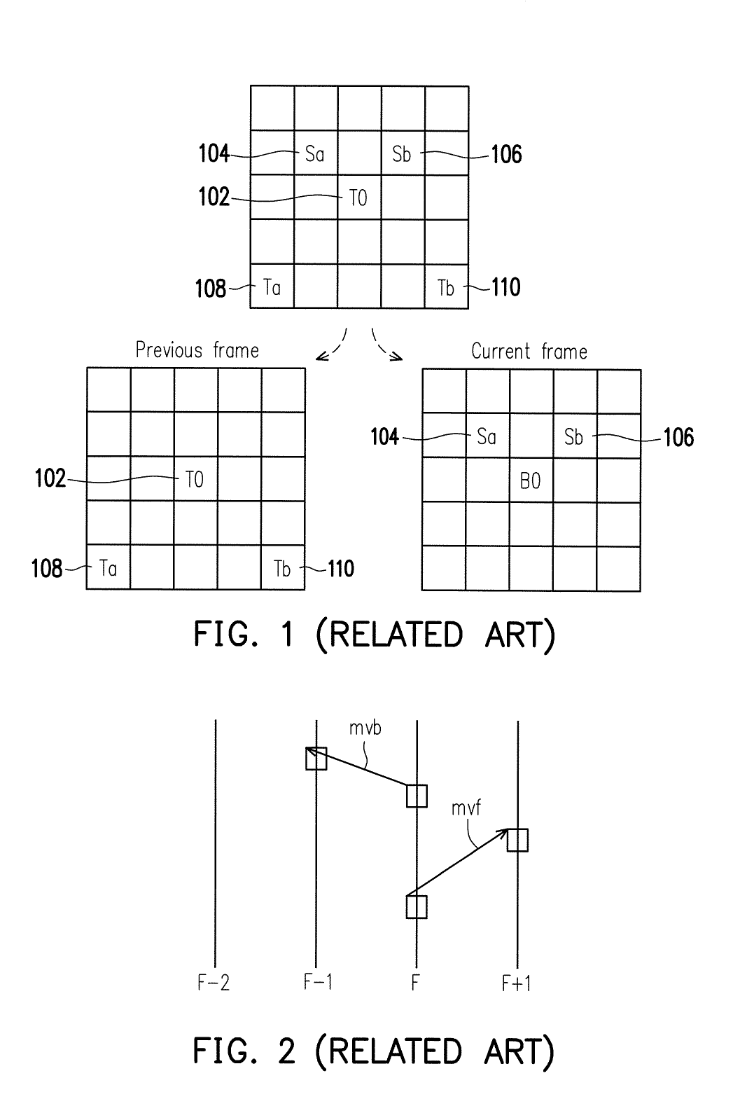

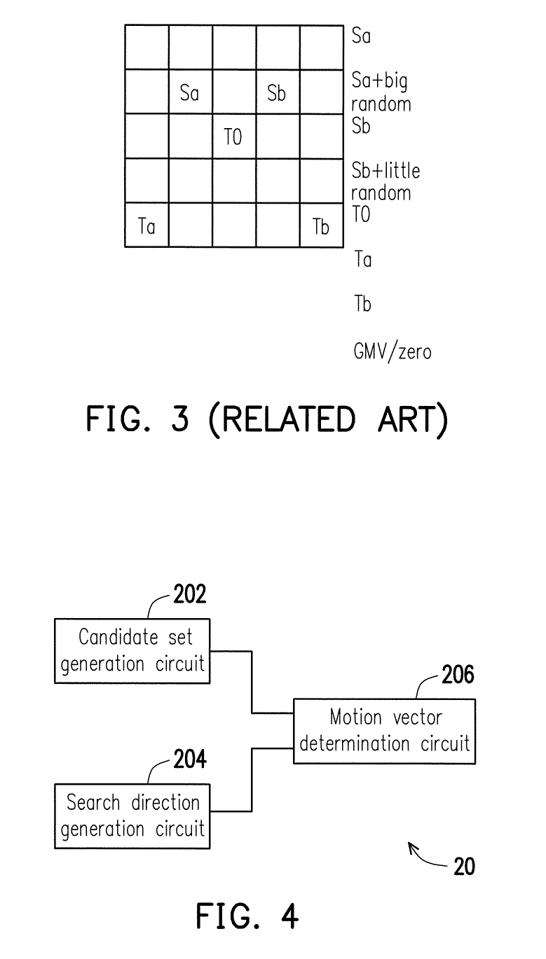

### DESCRIPTIONS OF EMBODIMENTS

Reference will now be made in detail to the exemplary embodiments of the disclosure, examples of which are illustrated in the accompanying drawings. The term “couple (or connect)” herein (including the claims) are used broadly and encompass direct and indirect connection or coupling means. For example, if the disclosure describes a first apparatus being coupled (or connected) to a second apparatus, then it should be interpreted that the first apparatus can be directly connected to the second apparatus, or the first apparatus can be indirectly connected to the second apparatus through other devices or by a certain coupling means. Moreover, elements/components/steps with same reference numerals represent same or similar parts in the drawings and embodiments. Elements/components/notations with the same reference numerals in different embodiments may be referenced to the related description.

Please refer to FIG. 4, which is a schematic diagram of a motion estimator 20 according to an exemplary embodiment of the invention. For illustration purposes, it is assumed that a video signal includes a plurality of frames. Each frame is divided into a plurality of blocks arranged in rows and columns. Each block includes one or more pixels. The motion estimator 20 is utilized for estimating motion vectors of blocks of each frame. The motion estimator 20 includes a candidate set generation circuit 202, a search direction generation circuit 204 and a motion vector determination circuit 206. The candidate set generation circuit 202 is utilized for selecting a candidate set associated with a current frame and a previous frame for each block of the current frame. For each block of the current frame, the candidate set may include at least one spatial motion vector from a block in the current frame and a plurality of temporal motion vectors from blocks in the previous frame. The search direction generation circuit 204 is utilized for selecting a search direction according to the candidate set. The motion vector determination circuit 206 is utilized for determining the motion vectors of the blocks of the current flame according to the search direction and determining respective motion vector for each block in the current frame according to the respective candidate set.

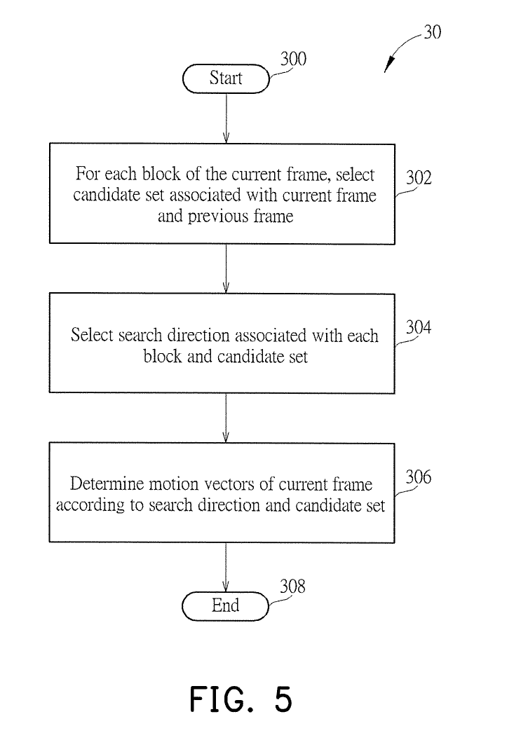

Please refer to FIG. 5 for the illustration of the operations of the motion estimator 20. Please refer to FIG. 5, which is a schematic diagram of a procedure 30 according to an exemplary embodiment of the invention. The procedure 30 can be utilized to estimate the motion vector for each block. The procedure 30 in FIG. 5 mainly corresponds to the operations on the motion estimator 20 shown in FIG. 4. Please note that those skilled in the art should observe that the method shown in FIG. 5 can include other intermediate steps, or several steps can be merged into a single step. The procedure 30 can include the following steps:
Step 300: Start.
Step 302: For each block of the current frame, select a candidate set associated with a current frame and a previous frame.
Step 304: Select a search direction associated with each block and candidate set.
Step 306: Determine motion vectors of the current frame according to the search direction and the candidate set.
Step 308: End.

According to the procedure 30, motion vectors of blocks corresponding to the current frame can be estimated. In Step 302, for each block of the current frame, the candidate set generation circuit 202 selects a candidate set associated with the current frame and the previous frame. The candidate set of the each block may include at least one spatial motion vector from a block in the current frame and a plurality of temporal motion vectors from blocks in the previous frame.

In an exemplary embodiment, the candidate set generation circuit 202 selects at least one spatial motion vector from a spatial adjacent block directly adjacent to each respective block from the current frame. Each spatial adjacent block may be located on the same row or column of the current frame as each respective block. The candidate set generation circuit 202 selects a plurality of temporal motion vectors from temporal adjacent blocks directly adjacent to a reference block in the previous frame. The reference block is located in the previous frame and spatially corresponds to the respective block of the current frame. That is, the reference block of the previous frame is at a same position with the respective block of the current frame. A relationship between the at least one spatial adjacent block and the plurality of temporal adjacent blocks may include at least one of the following: (a) when the at least one spatial adjacent block is located on the same row of the current frame as the each respective block, the plurality of temporal adjacent blocks are located on the same column of the previous frame as the reference block; and (b) when the at least one spatial adjacent block is located on the same column of the current frame as the respective block, the plurality of temporal adjacent blocks are located on the same row of the previous frame as the reference block.

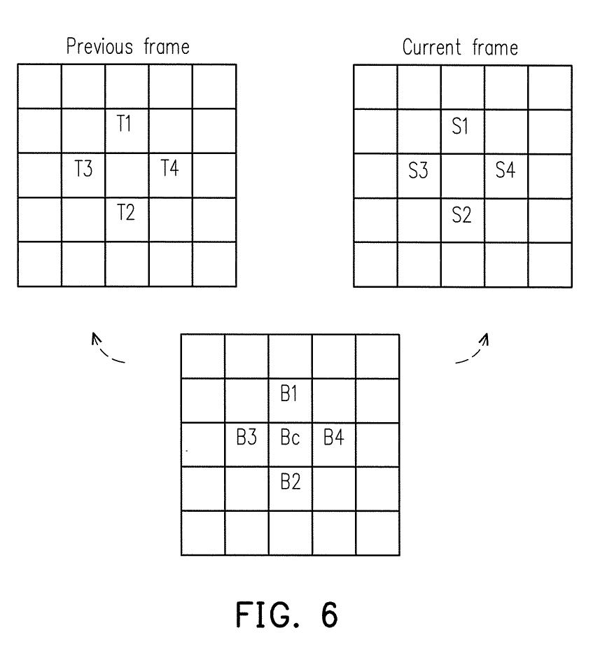

FIG. 6 shows a motion vector candidate set of a current block Bc of a current frame F in accordance with an exemplary embodiment of the invention. The current block Bc has candidate motion vectors from four immediately adjacent blocks B1 to B4, each of which is located at immediate top, bottom, left and right neighbors of the current block Bc. The motion vector of each of the blocks B1 to B4 can be a temporal motion vector (which refers to a motion vector of a block located at a previous frame) or a spatial motion vector (which refers to a motion vector of a block located at the current frame F). Once any one of the blocks B1 to B4 in the current frame F finishes a motion estimation process before a motion estimation process for the current block Bc, it gets a spatial motion vector as a candidate motion vector for the current block Bc.

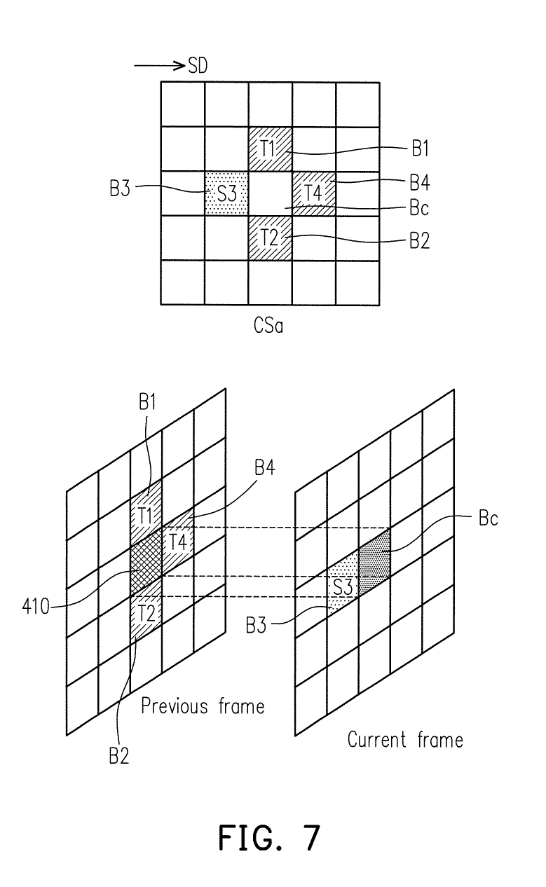

For example, please refer to FIGS. 7 to 10, which are schematic diagrams of the candidate set according to embodiments of the invention. FIG. 7 shows a case of a candidate set CSa of a current block Bc, a searching direction SD thereof and a processing sequence from left to right according to the searching direction SD. Referring to both FIG. 6 and FIG. 7, the candidate set CSa is selected for the current block Bc. The candidate set CSa includes a spatial motion vector S3, a temporal motion vector T1, a temporal motion vector T2 and a temporal motion vector T4. The spatial adjacent block B3 is adjacent to the left edge of the current block Bc. The temporal adjacent blocks B1 and B2 are respectively adjacent to the top edge and the bottom edge of the reference block 410 in the previous frame. The temporal adjacent block B4 is adjacent to the right edge of the reference block 410 in the previous frame. The motion vector S3 of the spatial adjacent block B3 in the current frame and the motion vectors T1, T2 and T4 of the temporal adjacent blocks B1, B2 and B4 may be estimated before the motion vector of the current block Bc is determined. As such, the candidate motion vector S3 of the spatial adjacent block B3 and the candidate motion vectors T1, T2 and T4 of the temporal adjacent blocks B1, B2 and B4 are selected into the candidate set CSa of the current block Bc.

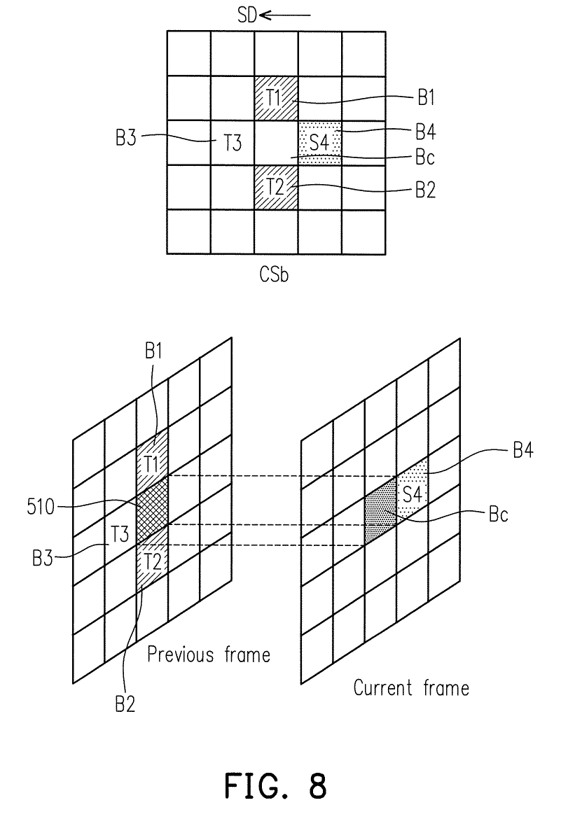

FIG. 8 shows a case of a candidate set CSb of a current block Bc, a searching direction SD thereof and a processing sequence from right to left according to the direction SD. Referring to both FIG. 6 and FIG. 8, the candidate set CSb is selected for the current block Bc. The candidate set CSb includes a spatial motion vector S4, a temporal motion vector T1, a temporal motion vector T2 and a temporal motion vector T3. The spatial adjacent block B4 is adjacent to the right edge of the current block Bc. The temporal adjacent blocks B1 and B2 are respectively adjacent to the top edge and the bottom edge of the reference block 510 in the previous frame. The temporal adjacent block B3 is adjacent to the left edge of the reference block 510 in the previous frame. Similarly, the motion vector S4 of the spatial adjacent block B4 and the motion vectors T1, T2 and T3 of the temporal adjacent blocks B1, B2 and B3 may be used as candidate motion vectors of the current block Bc.

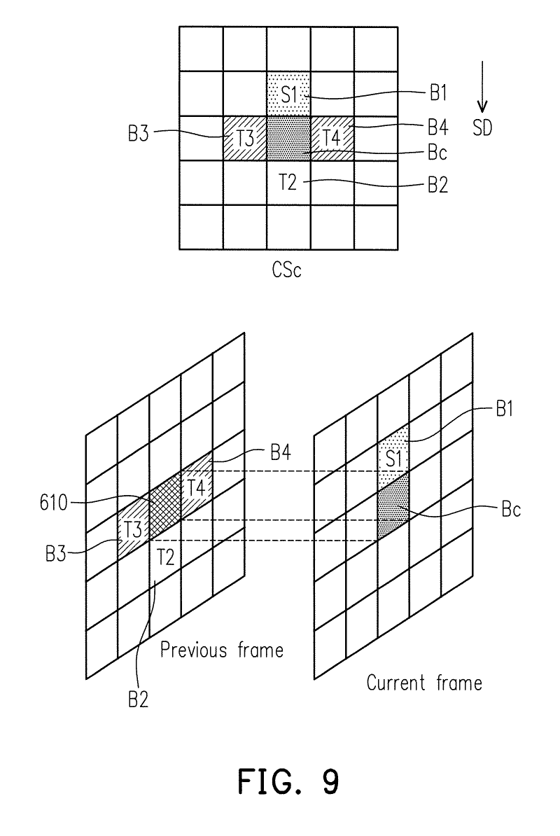

FIG. 9 shows a case of a candidate set CSc of a current block Bc, a searching direction SD and a processing sequence from top to bottom according to the direction SD. Referring to both FIG. 6 and FIG. 9, the candidate set CSc is selected for the current block Bc. The candidate set CSc includes a spatial candidate motion vector S1, a temporal candidate motion vector T2, a temporal candidate motion vector T3 and a temporal candidate motion vector T4. The spatial adjacent block B1 is adjacent to the top edge of the current block Bc. The temporal adjacent block B2 is adjacent to the bottom edge of the reference block 610 in the previous frame. The temporal adjacent blocks B3 and B4 are respectively adjacent to the left edge and the right edge of the reference block 610 in the previous frame. Similarly, the motion vector S1 of the spatial adjacent block B1 and the motion vectors T2, T3 and T4 of the temporal adjacent blocks B2, B3 and B4 may be used as candidate motion vectors of the current block Bc.

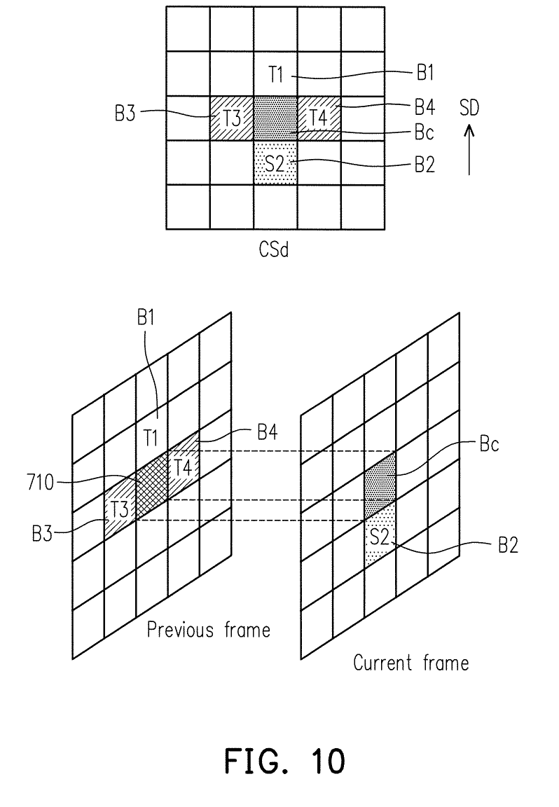

FIG. 10 is a case of candidate set CSd of a current block Bc showing a searching direction SD and accordingly a processing sequence being from bottom to top. Referring to both FIG. 6 and FIG. 10, the candidate set CSd is selected for the current block Bc. The candidate set CSd includes a spatial candidate motion vector S2, a temporal candidate motion vector T1, a temporal candidate motion vector T3 and a temporal candidate motion vector T4. The spatial adjacent block B2 is adjacent to the bottom edge of the current block Bc. The temporal adjacent blocks B1 is adjacent to the top edge of the reference block 710 in the previous frame. The temporal adjacent blocks B3 and B4 are respectively adjacent to the left edge and the right edge of the reference block 710 in the previous frame. Similarly, the motion vector S2 of the spatial adjacent block B2 and the motion vectors T1, T3 and T4 of the temporal adjacent blocks B1, B3 and B4 may be used as candidate motion vectors of the current block Bc.

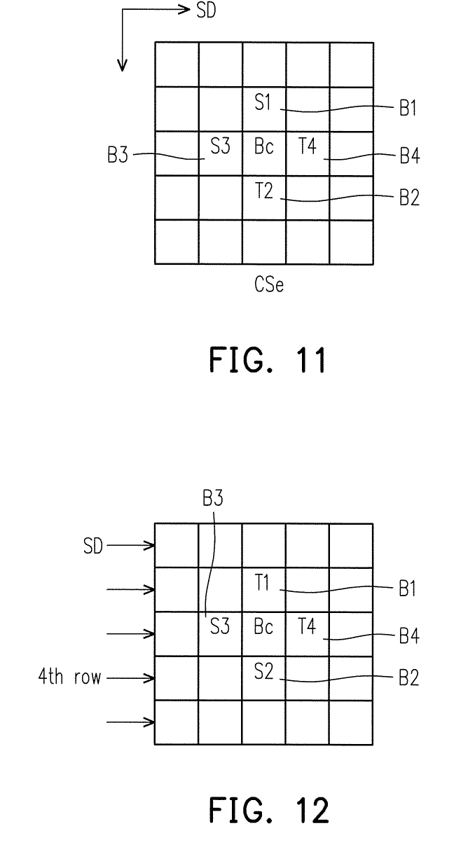

FIG. 11 shows a case of a candidate set CSe of a current block Bc, a searching direction SD and a processing sequence from top to bottom and left to right according to the direction SD. Referring to both FIG. 6 and FIG. 11, the candidate set CSe is selected for the current block Bc. The candidate set CSe includes a spatial candidate motion vector S1, a spatial candidate motion vector S3, a temporal candidate motion vector T2 and a temporal candidate motion vector T4. The spatial adjacent blocks B1 and B3 are respectively adjacent to the top edge and the left edge of the current block Bc. The temporal adjacent blocks B2 and B4 are respectively adjacent to the bottom edge and the right edge of the reference block in the previous frame. Similarly, the motion vectors S1 and S3 of the spatial adjacent blocks B1 and B3 and the motion vectors T2 and T4 of the temporal adjacent blocks B2 and B4 may be used as candidate motion vectors of the current block Bc.

FIG. 12 shows a case which applies parallel processing among rows while the 4^{th} row leads the others, such that the motion vector of the spatial adjacent block B2 and the motion vector of the spatial adjacent block B3 are selected as the spatial candidate motion vectors S2 and S3 of the current block Bc, and the motion vectors of the temporal adjacent blocks B1 and B4 in the previous frame may be used as the candidate motion vectors T1 and T4 of the current block Bc.

In the cases of FIGS. 7 to 12, each corresponding candidate set may further include big random displacement and little random displacement of the spatial motion vectors and a zero/global motion vector (GMV) similar to that applied in 3DRS for better coverage.

In Step 304, the search direction generation circuit 204 selects a search direction according to the candidate set for estimating motion vectors of the current frame. The search direction may be associated with the respective block and the spatial adjacent block. In an exemplary embodiment, the search direction is a direction from the corresponding spatial adjacent block to the respective block. For example, as show in FIG. 7, a search direction SD from left to right may be selected by the search direction generation circuit 204 when the spatial adjacent block B3 is adjacent to the left edge of the current block Bc. Similarly, as shown in FIG. 8, a search direction SD from right to left may be selected by the search direction generation circuit 204 when the spatial adjacent block B4 is adjacent to the right edge of the current block Bc. As show in FIGS. 9 to 10, a search direction SD may be selected respectively based on the locations of the respective spatial adjacent block and the respective current block.

On the other hand, the search direction generation circuit 204 may select a search direction, and then the candidate set generation circuit 202 may select a candidate set based on the search direction selected by the search direction generation circuit 204. For example, when the search direction generation circuit 204 selects a left-to-right direction as the search direction, the candidate set generation circuit 202 selects the candidate set CSa as shown in FIG. 7 based on the selected search direction.

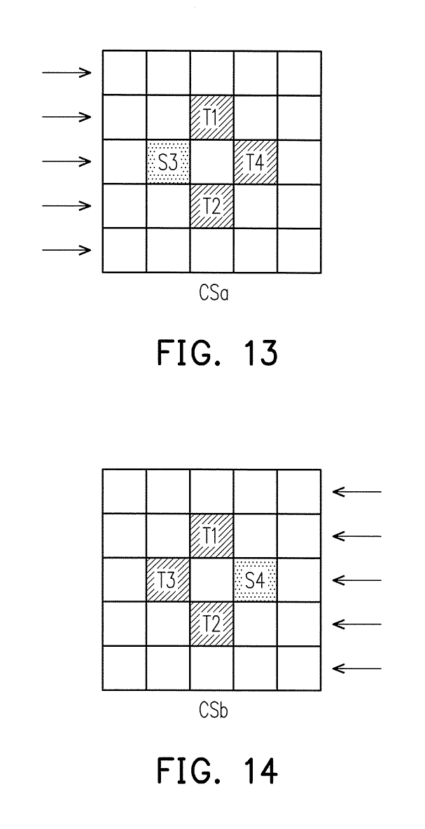

In Step 306, the motion vector determination circuit 206 determines the motion vectors of the current frame according to the search direction selected by the search direction generation circuit 204 and determines the respective motion vector according to the respective candidate set selected by the candidate set generation circuit 202 for each respective block. For the current frame, the motion vector determination circuit 206 may determine the motion vectors of the current frame in the search direction selected by the search direction generation circuit 204. For example, please refer to FIG. 13, since the search direction and the candidate set CSa as shown in FIG. 7 are selected, the motion vector determination circuit 206 sequentially determines the motion vectors of the blocks from left to right. When estimating the motion vectors for the first row of the current frame, the motion vector determination circuit 206 sequentially determines the motion vectors of blocks on the first row (i.e. from the first block of the first row to the last block of the first row). In this manner, when estimating the motion vectors for the second row of the current frame, the motion vector determination circuit 206 sequentially determines the motion vectors of blocks on the second row (i.e. from the first block of the second row to the last block of the second row).

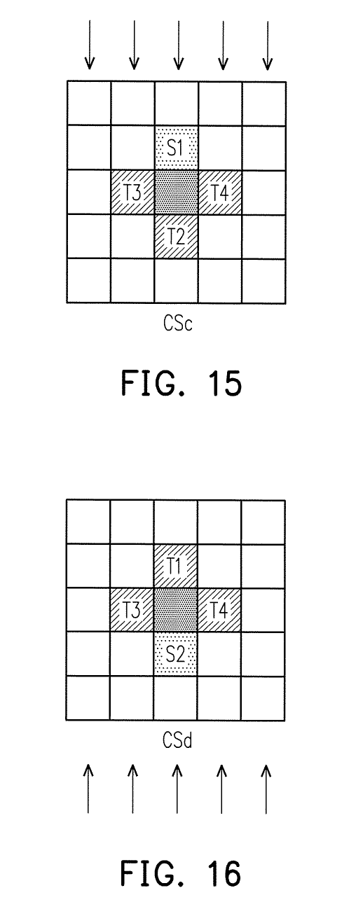

In a similar manner, please refer to FIG. 14, since the search direction and the candidate set CSb as shown in FIG. 8 are selected, the motion vector determination circuit 206 sequentially determines the motion vectors of the blocks from right to left. When estimating the motion vectors for each row of the current frame, the motion vector determination circuit 206 sequentially determines the motion vectors of the blocks on each row (i.e. from the last block of each row to the first block of each row). Please refer to FIG. 15, since the search direction and the candidate set CSc as shown in FIG. 9 are selected, the motion vector determination circuit 206 sequentially determines the motion vectors of the blocks from top to bottom. When estimating the motion vectors for the first column of the current frame, the motion vector determination circuit 206 sequentially determines the motion vectors of the blocks on the first column (i.e. from the first block of the first column to the last block of the first column). In this manner, when estimating the motion vectors for the second column of the current frame, the motion vector determination circuit 206 sequentially determines the motion vectors of the blocks on the second column (i.e. from the first block of the second column to the last block of the second column). Please refer to FIG. 16, since the search direction and the candidate set CSd as shown in FIG. 10 are selected, the motion vector determination circuit 206 sequentially determines the motion vectors of the blocks from bottom to top. When estimating the motion vectors for each column of the current frame, the motion vector determination circuit 206 sequentially determines the motion vectors of the blocks on each column (i.e. from the last block of each column to the first block of each column).

For each block of the current frame, the motion vector determination circuit 206 determines the respective motion vector according to the respective candidate set. For example, please further refer to FIG. 7, when the candidate set CSa as shown in FIG. 7 is selected for the current block Bc, the motion vector determination circuit 206 calculates difference values between the current block Bc and blocks respectively corresponding to the candidate motion vectors S3, T1, T2 and T4 of the candidate set CSa, and selects one of the candidate motion vectors S3, T1, T2 and T4 as the motion vector of the current block Bc according to the difference values.

Each of the difference values may be a sum-of-the-absolute difference (SAD) between pixels in the current block Bc and pixels in a block corresponding to a candidate motion vector of the candidate set CSa. In an exemplary embodiment, for the spatial candidate motion vector S3, the motion vector determination circuit 206 calculates an SAD value SAD1 between pixels in the current block Bc and pixels in the block corresponding to the candidate motion vector S3.

Moreover, the block corresponding to the candidate motion vectors S3 of the candidate set CSa may be in the previous frame (e.g., by using a backward motion estimation procedure) or in a frame next to the current frame (e.g., by using a forward motion estimation procedure). Since the motion vector of the spatial adjacent block B3 is estimated by using the backward motion estimation procedure, the block corresponding to the candidate motion vector S3 may be located in the previous frame by shifting the position of the current block Bc according to the candidate motion vector S3. Since the spatial candidate motion vector S3 is estimated by using the forward motion estimation procedure, the block corresponding to the candidate motion vector S3 may be located in a frame next to the current frame by shifting the position of the current block Bc according to the candidate motion vector S3.

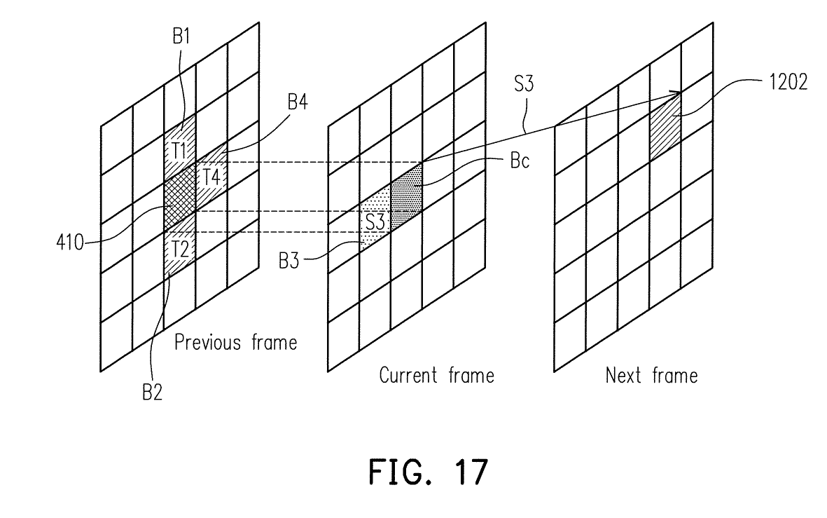

For example, please refer to FIG. 17 which is a schematic diagram representing the block corresponding to the spatial candidate motion vector S3 according to an exemplary embodiment of the invention. If it supposed that the candidate set CSa is selected and the motion vector of the spatial adjacent block B3 is estimated by using the forward motion estimation procedure. As such, the motion vector of the spatial adjacent block B3 is selected as the candidate motion vector S3 of the candidate set CSa of the current block Bc. For the spatial candidate motion vector S3, a block 1202 corresponding to the candidate motion vector S3 may be selected. As shown in FIG. 17, the block 1202 is located in the next frame by shifting the position of the current block Bc with a motion vector of the spatial adjacent block B3 (i.e. the candidate motion vector S3). Therefore, for the spatial candidate motion vector S3, the motion vector determination circuit 206 can calculate an SAD value SAD1 between pixels in the current block Bc and pixels in the block 1202 corresponding to the candidate motion vector S3.

For the temporal candidate motion vector T1, the motion vector determination circuit 206 calculates an SAD value SAD2 between pixels in the current block Bc and pixels in a block corresponding to the candidate motion vector T1. The block corresponding to the candidate motion vector T1 may be a block shifted by the candidate motion vector T1 for the current block Bc. The offset between the current block Bc and the block corresponding to the candidate motion vector T1 is equal to the motion vector of the temporal adjacent block B1. Similarly, since the motion vector of the temporal adjacent block B1 is estimated by using the backward motion estimation procedure, the block corresponding to the candidate motion vector T1 may be located in the previous frame by shifting the position of the current block Bc according to the motion vector of the temporal adjacent block B1. Since the motion vector of the temporal adjacent block B1 is estimated by using the forward motion estimation procedure, the block corresponding to the candidate motion vector T1 may be located in a frame next to the current frame by shifting the position of the current block Bc according to the motion vector of the temporal adjacent block B1.

For the temporal candidate motion vector T2, the motion vector determination circuit 206 calculates an SAD value SAD3 between pixels in the current block Bc and pixels in a block corresponding to the candidate motion vector T2. The block corresponding to the candidate motion vector T2 may be a block shifted by the candidate motion vector T2 for the current block Bc. The offset between the current block Bc and the block corresponding to the candidate motion vector T2 is equal to the motion vector of the temporal adjacent block B2. Similarly, since the motion vector of the temporal adjacent block B2 is estimated by using the backward motion estimation procedure, the block corresponding to the candidate motion vector T2 may be located in the previous frame by shifting the position of the current block Bc according to the motion vector of the temporal adjacent block B2. Since the motion vector of the temporal adjacent block B2 is estimated by using the forward motion estimation procedure, the block corresponding to the candidate motion vector T2 may be located in a frame next to the current frame by shifting the position of the current block Bc according to the motion vector of the temporal adjacent block B2.

Moreover, the motion vector determination circuit 206 compares the SAD values SAD1, SAD2 and SAD3 and selects a minimum of the SAD values SAD1, SAD2 and SAD3. For example, if the SAD value SAD2 is the minimum SAD value, the motion vector determination circuit 206 selects the motion vector of the temporal adjacent block B1 to serve as the motion vector of the current block Bc. In other words, since the motion vector of each of the spatial adjacent block(s) and the temporal adjacent blocks have already been estimated during the previous procedure, the motion vectors of each of the spatial adjacent block(s) and the temporal adjacent blocks may be used as candidate motion vectors of the current estimating block. The motion vector determination circuit 206 may select one candidate motion vector with the minimum SAD value from the corresponding candidate set and determine the candidate motion vector with the minimum SAD value as the motion vector of the current block Bc.

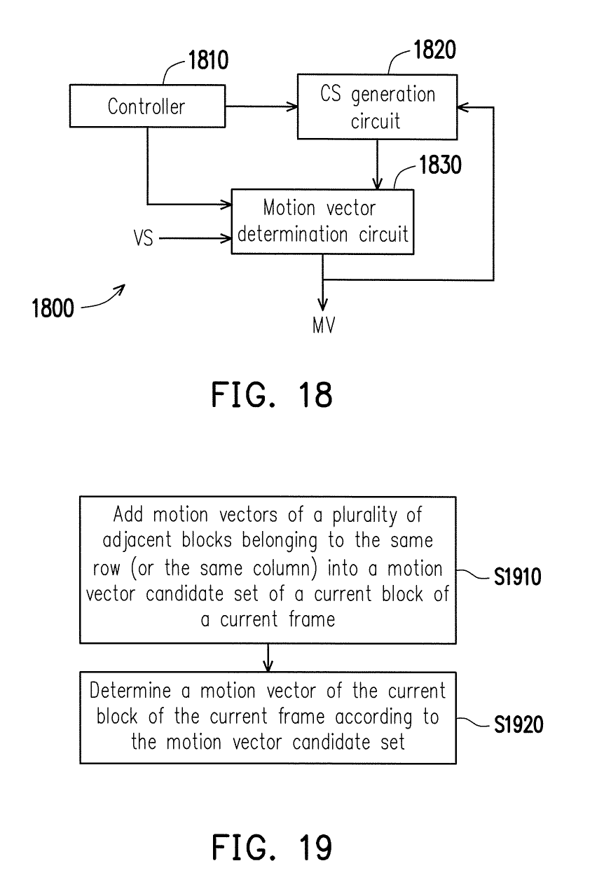

FIG. 18 is a schematic circuit block showing a motion estimation apparatus 1800 according to another exemplary embodiment of the invention. The motion estimation apparatus 1800 includes a controller 1810, a candidate set generation circuit 1820 and a motion vector determination circuit 1830. The candidate set generation circuit 1820 generates a candidate set for each block in a video frame according to design requirements. The motion vector determination circuit 1830 is coupled to the candidate set generation circuit 1820 to receive candidate motion vectors therefrom, receive a video stream VS containing a series of image frames, divide each frame into blocks, and perform motion estimation for each of the blocks according to respective corresponding candidate motion vectors received from the candidate set generation circuit 1820 to obtain a motion vector MV for each of the blocks. The motion vector MV of a block is also provided to the candidate set generation circuit 1820 to be a candidate motion vector of the other blocks of the current frame as candidate spatial motion vector or the subsequent frame as candidate temporal motion vector.

The controller 1810 is coupled to the candidate set generation circuit 1820 and the motion vector determination circuit 1830. The controller 1810 determines a searching direction for each of the blocks, and controls the overall processing flow of the motion estimation. Based on design requirements, the motion estimation apparatus 1800 shown in FIG. 18 may be implemented as a circuit such as a integrated circuit or a software code run on a general purpose processor (e.g., a CPU) of a single or multiple core architecture, or a combination of both hardware circuitry and software code, e.g. an ASIC with hardware building blocks and firmware codes.

FIG. 19 is a flowchart of a motion estimation method according to another exemplary embodiment of the invention. Please refer to FIG. 18 and FIG. 19. In Step S1910, the candidate set generation circuit 1820 may select to add motion vectors of a plurality of adjacent blocks into a motion vector candidate set of a current block of a current frame. Therein, one of the adjacent blocks and the current block belong to the same row (or the same column), and the one of the adjacent blocks is a block in the current frame or a block in a previous frame. The motion vector determination circuit 1830 is coupled to the candidate set generation circuit 1820 to receive the motion vector candidate set. In Step S1920, the motion vector determination circuit 1830 may determine a motion vector of the current block of the current frame according to the motion vector candidate set.

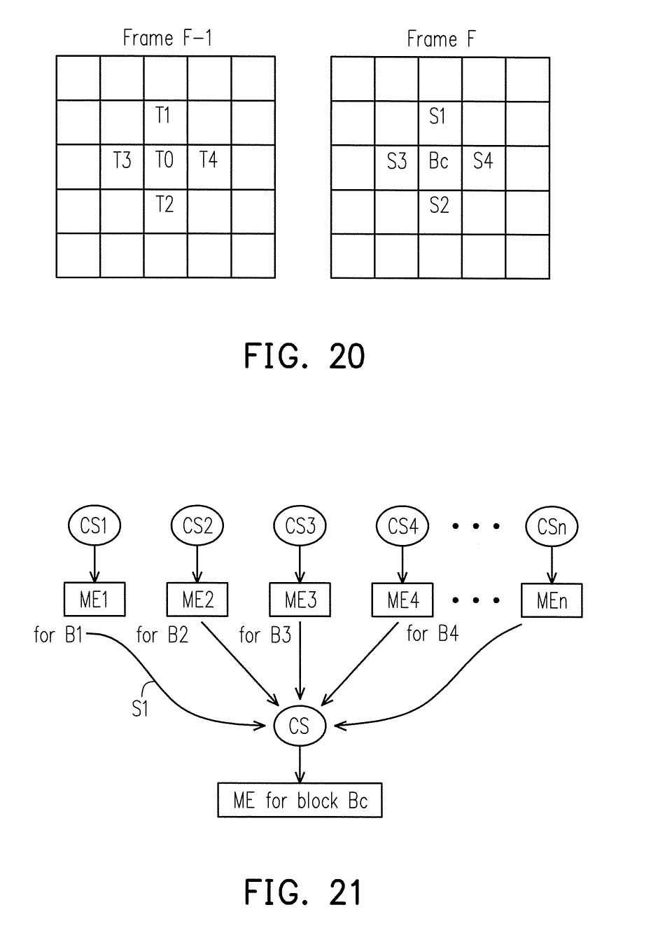

FIG. 20 shows an exemplary embodiment relative to the exemplary embodiment of FIG. 6. A possible candidate set of a current block Bc in which a temporal motion vector T0 from a block corresponding to the block Bc in the previous frame F−1 is added as a candidate motion vector of the current block Bc of the current frame F.

FIG. 21 shows sources of the motion vector candidate set CS according to an exemplary embodiment of the invention. There are n motion estimation processes ME1, ME2, ME3, ME4, . . . and MEn performed for generating candidate motion vectors of the candidate set CS incorporated with the motion estimation process of the current block Bc. Each of the motion estimation processes ME1 to MEn processes incorporates a corresponding candidate set (i.e. motion vector candidate sets CS1, CS2, CS3, CS4, and CSn). The motion estimation processes ME1 to ME4 are arranged to respectively perform motion estimations for the blocks B1 to B4 along a searching and processing direction of top to bottom. Accordingly, the motion estimation process ME1 generates a motion vector S1 to serve as a spatial candidate motion vector for the motion estimation process ME of the current block Bc. This case simulates the scenario of FIG. 9.

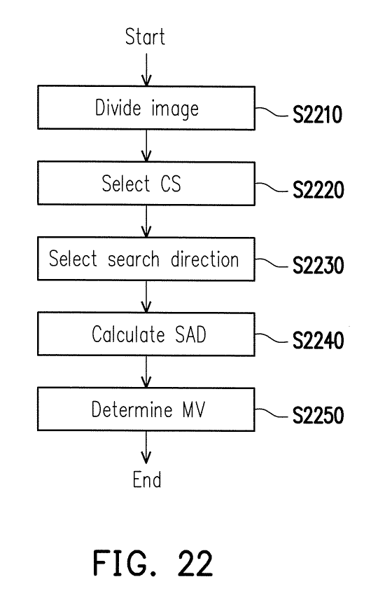

FIG. 22 is a flowchart of a motion estimation method according to yet another exemplary embodiment of the invention. In Step S2210, an image frame is divided into blocks. In Step S2220, for each block, the candidate set generation circuit 1820 selects a candidate set CS for the current block Bc. In Step S2230, the controller 1810 selects the searching direction SD for processing motion estimation for the current block Bc. In Step S2240, the motion vector determination circuit 1830 calculates SAD values of the current block Bc with reference blocks, each of which corresponds to one of the candidate motion vectors in the candidate set CS. In Step S2250, the motion vector determination circuit 1830 determines a best matched motion vector among the candidate motion vectors to serve it as the motion vector of the current block Bc.

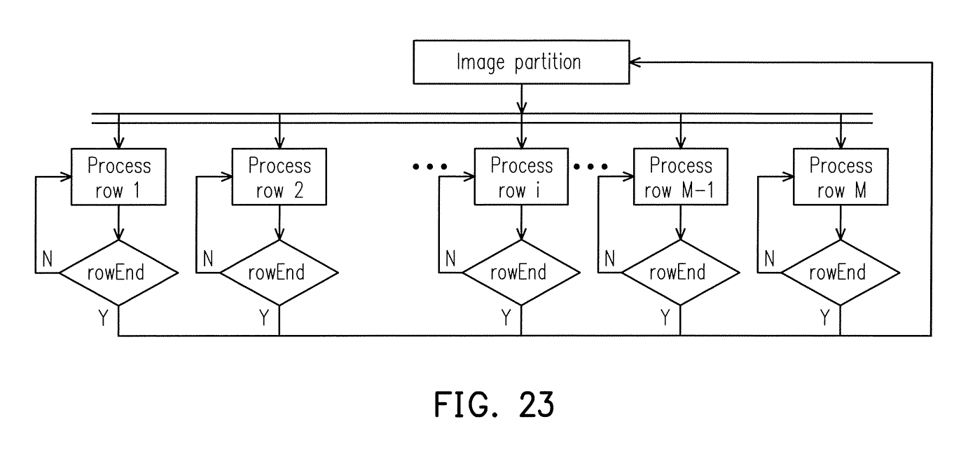

FIG. 23 is a schematic diagram showing a parallel processing flow of the motion estimation method according to yet another exemplary embodiment of the invention. In the example illustrated in FIG. 23, the motion vector determination circuit 1830 may perform the parallel processing on a plurality of rows. An image frame is divided into M rows and N blocks per row. The motion estimation processes of the motion vector determination circuit 1830 are performed in parallel row by row. This can be achieved because, in the present exemplary embodiment, the candidate set CS of the current block Bc under processing arranges a candidate spatial motion vector from an adjacent block located on the same row as the block (e.g. the cases of FIG. 7, FIG. 8, and/or FIG. 12). Similarly, the parallel processing can be arranged in columns (e.g. the cases of FIG. 9 and/or FIG. 10). The arrangement of the parallel processing may speed up the processing and may also improve a convergence rate since the candidate set CS of the current block Bc may probably have more spatial motion vectors from the adjacent blocks ready before the processing of the block itself is started (e.g. the case of FIG. 12).

Referring to FIGS. 6 to 12 and 20 to 21, it is evident that for a motion estimation process of a current block Bc of a current frame, the candidate set CS may include at least one spatial candidate motion vector from an adjacent block located on the same row or column of the current block Bc in the current frame. This may improve the coverage of the motion vector candidate set CS over the 3DRS approach and consequently increase convergence rate in obtaining accurate motion vectors for the current block Bc. Further, the motion vector candidate set CS also facilitates the parallel processing for the motion estimation processes, thereby speeding up the processing.

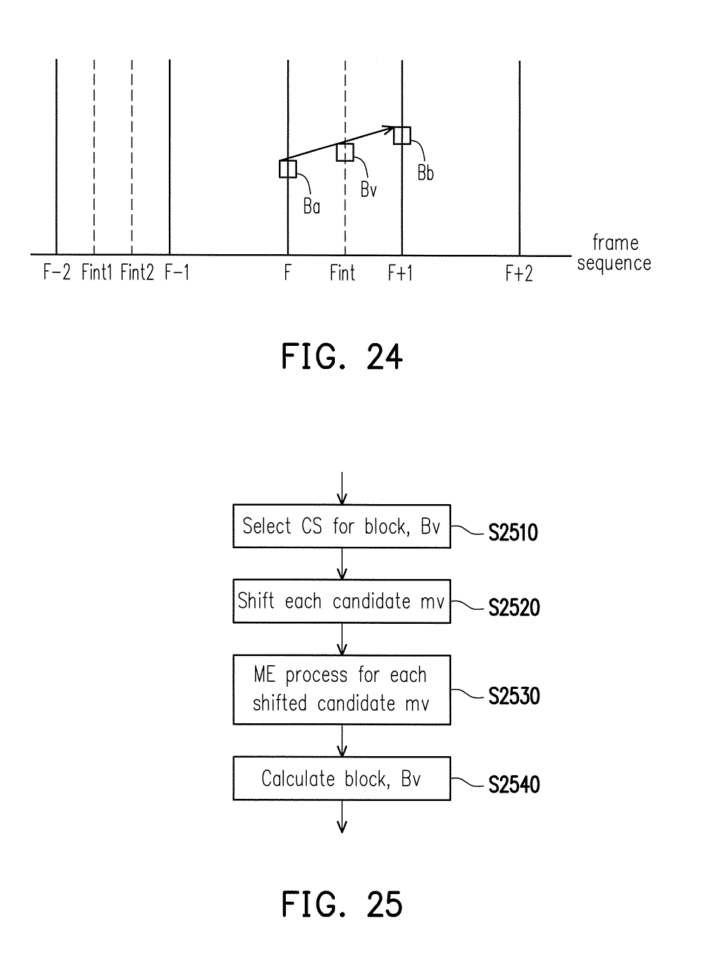

FIG. 24 is a schematic diagram showing the processing of frame rate up conversion (FRC) according to an exemplary embodiment of the invention. In the example illustrated in FIG. 24, one or more frames between two original frames may be generated, for example, a frame Fint is an interpolation frame between consecutive frames F and F+1, and frames Fint1 and Fint2 are interpolation frames between original frames F−1 and F−2.

FIG. 25 is a flowchart of a motion estimation method according to an exemplary embodiment of the invention. In the examples shown in FIG. 24 and FIG. 25, the determination of the interpolation frame Fint is generated from the original frames F and F+1. For each block By of the interpolation frame Fint, a motion vector candidate set CS is selected for a block By of the interpolation frame Fint (Step 1). Each of the candidate motion vectors of the motion vector candidate set CS is shifted in parallel to pass through the block By of the interpolation frame Fint (Step 2). The motion estimation processes with each of the shifted candidate motion vectors are performed to obtain a best matched motion vector, which originates from a block Ba located at the frames F and points to another block Bb located at the other frame F+1 via block By (Step 3). The block By is calculated by a combination of blocks Ba and Bb (Step 4). The processes performed in Step 3 are defined as projected motion estimation processes and the best matched motion vector is called a projected motion vector.

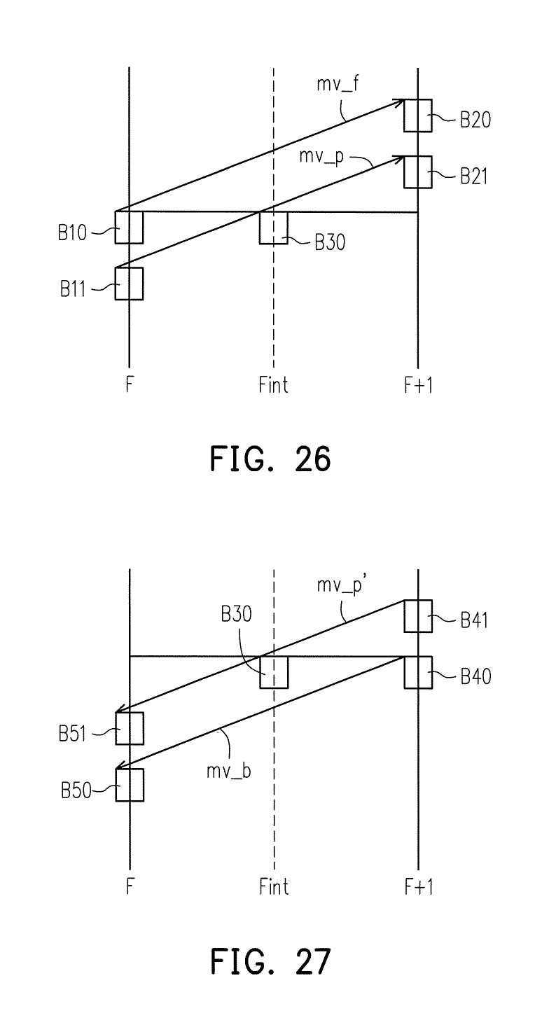

FIG. 26 shows an example for the projected motion estimation process. A candidate motion vector MV_f of the motion vector candidate set CS is taken here. The motion vector MV_f is from a previous forward motion estimation performed for a block B10 in the frame F with the reference frame F+1 and gets a best matched block B20 in the frame F+1. The motion vector MV_f is shifted in parallel to pass through a block B30 in the interpolation frame Fint to obtain a shifted motion vector MV_p. The motion vector MV_p is thus pointed from a block B11 in the frame F to a block B21 in the frame F+1. The blocks B11 and B21 are verified with similarity by a forward motion estimation which is a kind of projected motion estimation associated with the block B30, and the motion vector MV_p is called a projected motion vector of the block B30 if it is the best matched one among the candidate motion vectors of the motion vector candidate set CS. The block B30 can be generated by a combination of both blocks B11 and B21. Preferably, bi-linear combination of the blocks B11 and B21 is applied, such that B30=r*B11+(1−r)*B21, wherein r may be determined by many factors and design requirements. For example, a consideration of the parameter r may include the relative time distance of the frame Fint to each of the frames F−1 and F.

Similarly, the above procedure can be done with another candidate motion vector. FIG. 27 shows another example for the projected motion estimation process. The above procedure can be done with the motion vector MV_b of the motion vector candidate set CS. The motion vector MV_b is from a backward motion estimation for a block B40 in the frame F+1 with the reference frame F and gets a best matched block B50 in the frame F. The motion vector MV_b is shifted in parallel to pass through the block B30 of the interpolation frame Fint to obtain a shifted motion vector MV_p′. The motion vector MV_p′ is thus pointed from a block B41 in the frame F+1 to a block B51 in the frame F. The block B41 and the block B51 are verified with similarity by another backward motion estimation which is another kind of projected motion estimation associated with the block B30, and the motion vector MV_p′ is called a projected motion vector of the block B30 if it is the best matched one among the candidate motion vectors of the motion vector candidate set CS. The block B30 can be generated by a combination of both blocks B41 and B51.

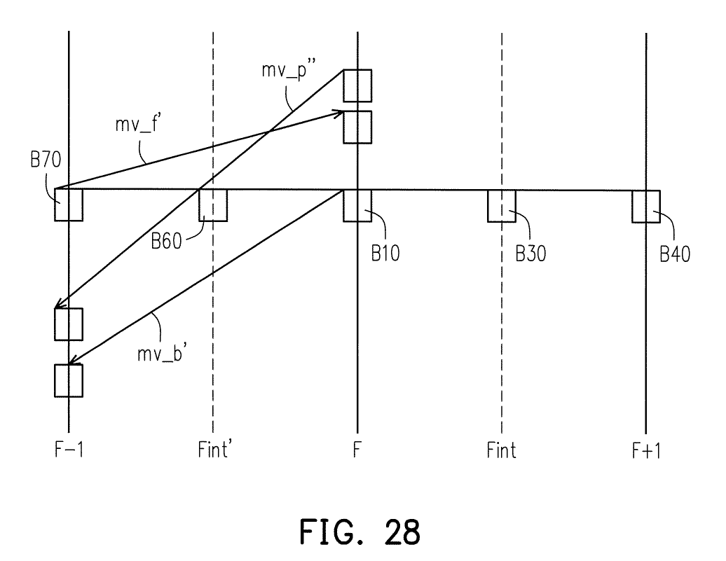

The candidate motion vectors of the block B30 of the interpolation frame Fint may be selected from previously performed motion estimation processes between the frames F and F+1, such as that shown in FIGS. 26 and 27, and also the motion estimation processes that are previously performed during generating interpolation frames between frames F−1 and F, including forward, backward and projected motion estimation processes. For example, FIG. 28 shows that a forward motion vector MV_f′ and a backward motion vector MV_b′ from each motion estimation process performed between the frames F−1 and F are selected as a candidate motion vector for the block B30 of the interpolation frame Fint. FIG. 28 further shows that a projected motion vector MV_p″ of an interpolation frame Fint′ between the frames F−1 and F is also selected as a candidate motion vector for the block B30. Preferably, candidate motion vectors of the block B30 are selected from that of blocks locate at a same position in each frame as the position of the block B30 locates at the interpolation frame Fint. For example, the block B10 of the frame F, the block B40 of the frame F+1, the block B70 of the frame F−1, and the block B60 of the frame Fint′ are located in the same position in each frame as the location of the block B30 in the interpolation frame Fint as shown in FIGS. 26, 27 and 28, respectively. This facilitates convergence in obtaining an accurate motion vector for the block B30.

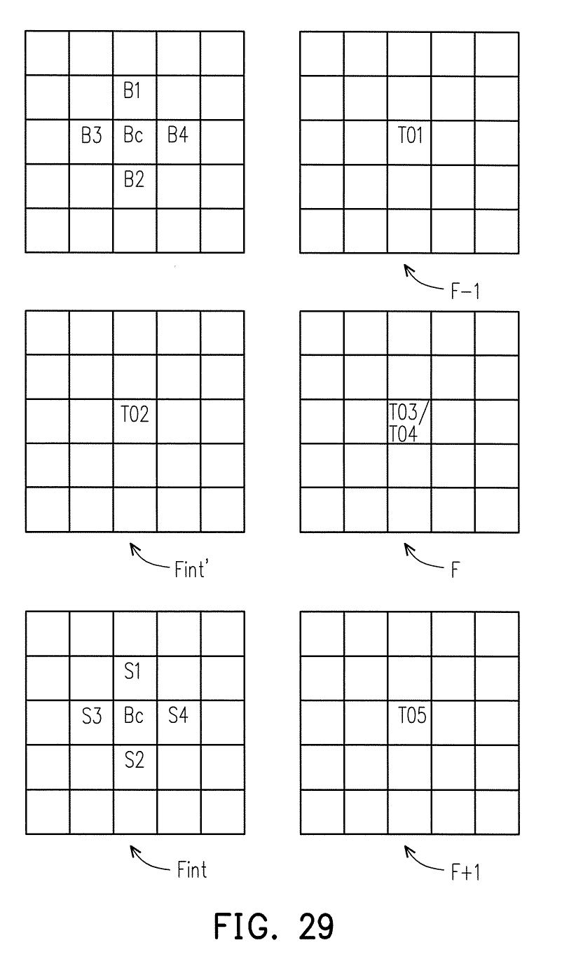

FIG. 29 exemplarily illustrates that a possible candidate set CS of a current block Bc of a frame may include a plurality of temporal motion vectors from more than one adjacent frames at the same block position of the current block Bc in addition to the spatial and temporal motion vectors from adjacent blocks of the current and previous frames as shown in FIG. 20. The adjacent frames may include original and interpolation frames. This example refers to FIGS. 26, 27 and 28 to illustrate a case of the motion vector candidate set CS for a projected motion estimation process, wherein the motion vectors T01, T02, T03, T04 and T05 correspond to the motion vectors MV_f′, MV_p″, MV_f, MV_b′ and MV_b of FIGS. 26, 27 and 28, respectively. The motion vector candidate set CS may further include big random displacement and little random displacement of the spatial motion vectors and a zero motion vector (or a GMV) as that used in 3DRS for better coverage. Although there are a lot of possibilities for selecting candidate motion vectors of the motion vector candidate set CS, processing efficiency is always crucial in the consideration of selection. For example, the motion vector MV_p″ is highly correlated with the motion vectors MV_f′ and MV_b′, and practically, it is not necessary to select all of them to the motion vector candidate set CS. Given a selected candidate set CS, there is still a selection of a searching direction for the motion estimation processes that can affect some candidate motion vectors from the adjacent blocks, e.g. some temporal motion vectors associated with the adjacent blocks would become spatial motion vectors as searching direction is changed, as those described in FIGS. 7 to 12.

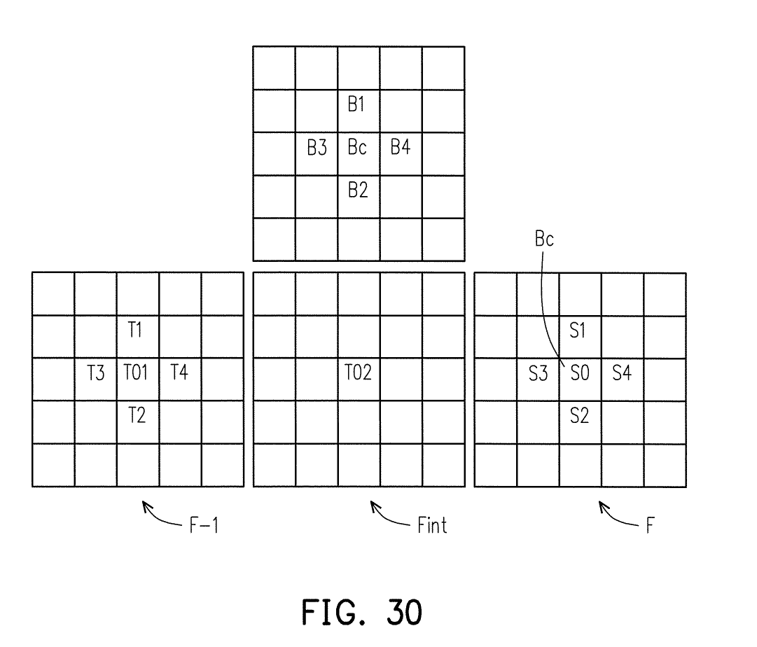

FIG. 30 shows a possible candidate set CS for a forward motion estimation process. A forward motion estimation for the block B10 of the frame F as shown in FIGS. 26, 27 and 28 is taken as example, that is, the current block Bc is the block B10 of the frame F in this case. Candidate motion vectors of the motion vector candidate set CS may contain the motion vectors T01, T02 and S0 from the blocks of adjacent and current frames of the same block location as the current block Bc (i.e. the block B10 of frame F in FIGS. 26, 27 and 28), wherein the motion vectors T01, T02 and S0 correspond to the motion vector MV_f′ (the forward motion vector of the block B70 in FIG. 28), the motion vector MV_p″ (the projected motion vector of the block B60 in FIG. 28) and the motion vector MV_b′ (the backward motion vector of the block B10 in FIG. 28), respectively. The motion vector candidate set CS may further contain spatial motion vectors and temporal motion vectors from adjacent blocks, big random displacement and little random displacement of the spatial motion vectors as well as a zero motion vector (or a GMV) as described earlier.

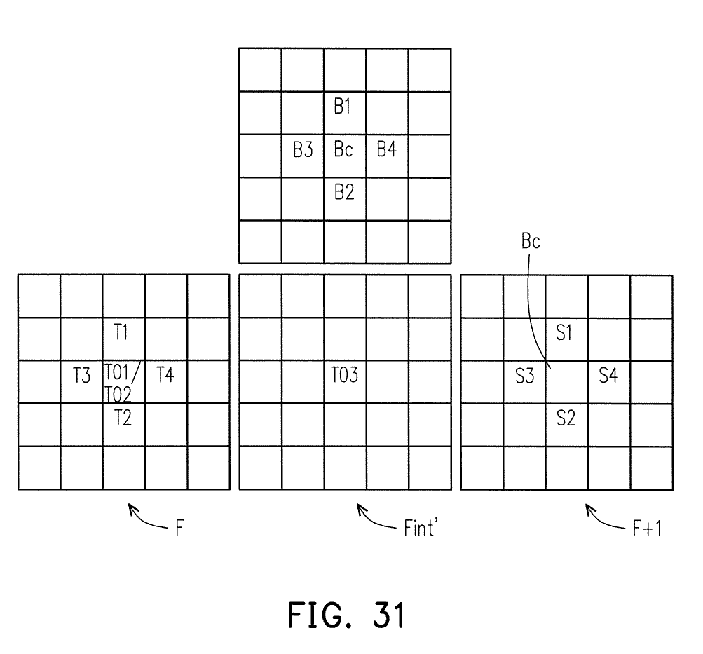

FIG. 31 shows a possible candidate set CS for a backward motion estimation process. In this case, a backward motion estimation for the block B40 of the frame F+1 as shown in FIGS. 26, 27 and 28 is taken as example, that is, the current block Bc is the block B40 of the frame F+1 here. Candidate motion vectors of the motion vector candidate set CS may contain the motion vectors T01, T02 and T03 from the blocks of adjacent frames of the same block location as the current block Bc (i.e. the block B40 of frame F+1 in FIGS. 27 and 28), wherein the motion vectors T01, T02 and T03 correspond to the motion vector MV_f (the forward motion vector of the block B10 in FIG. 26), the motion vector MV_b′ (the backward motion vector of the block B10 in FIG. 28), and the motion vector MV_p″ (the projected motion vector of the block B60 in FIG. 28), respectively. The motion vector candidate set CS may further contain spatial motion vectors and temporal motion vectors from adjacent blocks, big random displacement and little random displacement of the spatial motion vectors as well as a zero motion vector (or a GMV) as described earlier.

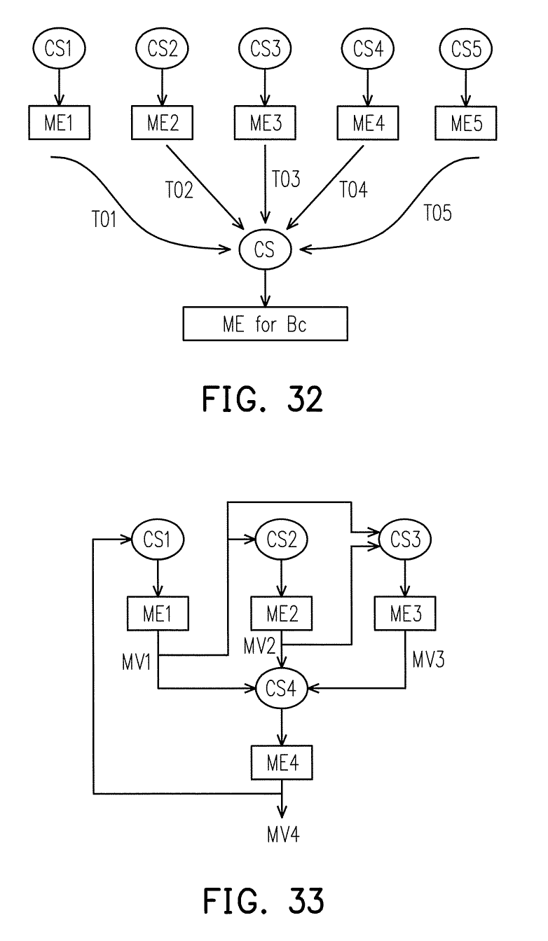

FIG. 32 shows sources of the candidate set CS according to another exemplary embodiment. In the exemplary embodiment shown in FIG. 32, there are 5 motion estimation processes ME1 to ME5 performed for generating candidate motion vectors of the motion vector candidate set CS incorporated with a motion estimation process of the current block Bc. Each of the motion estimation processes ME1 to ME5 incorporates a corresponding candidate set, i.e. motion vector candidate sets CS1 to CS5. In one embodiment as shown in FIG. 29, i.e. in a projected motion estimation scenario, the motion estimation processes ME1 to ME5 are arranged to respectively perform motion estimations for co-located blocks in each of the adjacent frames, wherein the position of the co-located blocks in the adjacent frames and the position of the current block Bc in the frame Fint are same. The motion estimation processes ME1 to ME5 output the candidate motion vectors T01 to T05 respectively to serve as the candidate motion vectors of the motion vector candidate set CS for the projected motion estimation process of the current block Bc. In another exemplary embodiment as shown in FIG. 30, i.e. in a forward motion estimation scenario, the motion estimation processes ME1 to ME3 are arranged to respectively perform the motion estimation processes for co-located blocks in each of the adjacent and current frames, wherein the position of the co-located blocks in the adjacent frames and the position of the current block Bc in the frame F are same. The motion estimation processes ME1 to ME3 output the candidate motion vectors T01, T02 and S0 respectively to serve as the candidate motion vectors of the candidate set CS for the forward motion estimation process of the current block Bc. In yet another embodiment as shown in FIG. 31, i.e. in a backward motion estimation scenario, the motion estimation processes ME1 to ME3 are arranged to respectively perform motion estimations for co-located blocks in each of the adjacent frames, wherein the position of the co-located blocks in the adjacent frames and the position of the current block Bc in the frame F+1 are same. The motion estimation processes ME1 to ME3 output the candidate motion vectors T01, T02 and T03 respectively to serve as the candidate motion vectors of the candidate set CS for the backward motion estimation process of the current block Bc.

Referring to FIGS. 29 to 32, it is evident that for a motion estimation process of a current block Bc of a frame, the candidate set CS may include more than one candidate motion vectors from blocks of the current and/or adjacent frames of the same location as the current block Bc. This improves the candidate set CS coverage over the 3DRS approach and consequently increases convergence rate in obtaining an accurate motion vector for the current block Bc.

FIG. 33 is a schematic diagram of the processing of a candidate set according to yet another exemplary embodiment. In the exemplary embodiment shown in FIG. 33, the candidate set associated with a current motion estimation process may be refined by one or more preceding motion estimation processes that are performed before, such that a target motion vector of the current motion estimation process may be refined. FIG. 33 shows this relation. The motion estimation process ME1 preceding the motion estimation processes ME2 to ME4 outputs its target motion vector MV1 to serve as a candidate motion vector for the motion estimation processes ME2 to ME4. The candidate sets CS2 to CS4 are thus refined. The motion estimation process ME2 preceding the motion estimation processes ME3 to ME4 outputs the motion vector MV2 to serve as the candidate motion vector for the motion estimation processes ME3 to ME4. The candidate sets CS3 to CS4 are thus further refined. The motion estimation process ME3 preceding the motion estimation process ME4 outputs the motion vector MV3 to serve as the candidate motion vector for the motion estimation process ME4. The candidate set CS4 is thus refined once more. Finally, the motion estimation process ME4 refers to the candidate set CS4 that are refined by the preceding motion estimation processes ME1 to ME3 to obtain a best matched motion vector MV4. By refining candidate set with the preceding motion estimation processes, the accuracy of the final target motion vector can be further improved.

In certain application cases, the final target motion vector of the last motion estimation process in a motion estimation chain may be provided to refine the candidate set of the beginning motion estimation and even the candidate set of the subsequent motion estimation processes (not shown) to have the motion estimation chain restart motion estimation processes with or without altering searching directions so as to refine the motion vector for each motion estimation stage and consequently refine the final target motion vector. For example, in FIG. 33, the motion vector MV4 may be used to refine candidate set CS1 for a second run motion estimation processes with the motion estimation chain. Generally, the reiterated motion estimation processes would also involve other new candidate motion vectors of each motion estimation stage by altering searching direction for each and by updating candidate motion vector from processing results of neighboring blocks in the first run. This further improves the accuracy of the final target motion vector.

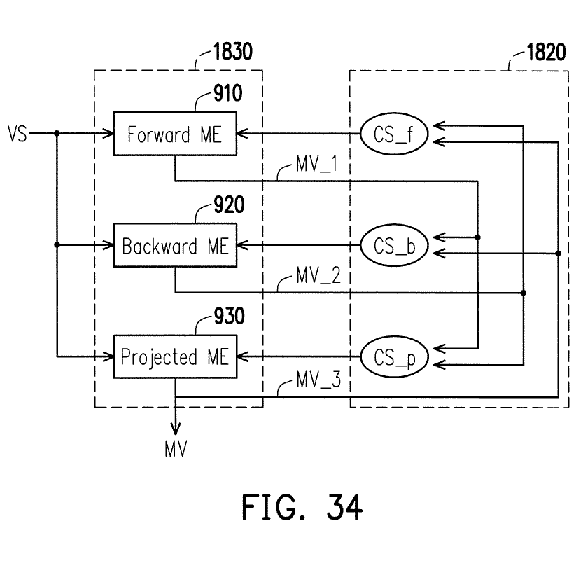

FIG. 34 is a schematic circuit block diagram showing the motion estimation apparatus 1800 depicted in FIG. 18 according to an exemplary embodiment of the invention, where a frame rate up conversion (FRC) example is shown to explain the refinement of candidate set by preceding motion estimation processes so as to refine target motion vector. Referring to FIG. 34, the motion vector candidate set provided by the candidate set generation circuit 1820 includes a first motion vector candidate set (e.g. a candidate set CS_f), a second motion vector candidate set (e.g. a candidate set CS_b) and a third motion vector candidate set (e.g. a candidate set CS_p), and the motion vector determination circuit 1830 includes a first motion estimator circuit (e.g. a circuit 910 for performing the forward motion estimation), a second motion estimator circuit (e.g. a circuit 920 for performing the backward motion estimation) and a third motion estimator circuit (e.g. a circuit 930 for performing the projected motion estimation) associated with the candidate sets CS_f, CS_b and CS_p, respectively. The forward motion estimation 910 uses the candidate set CS_f of the current block of the current frame to perform a first motion estimation operation (e.g. a forward motion estimation), so as to obtain a first motion vector (e.g. the motion vector MV_1) of the current block of current frame. The motion vector MV_1 provided by the forward motion estimation 910 is added into the candidate sets CS_b and CS_p of the current block of the current frame. The backward motion estimation 920 uses the candidate set CS_b of the current block of the current frame to perform a second motion estimation operation (e.g. a backward motion estimation), so as to obtain a second motion vector (e.g. the motion vector MV_2) of the current block of the current frame. The motion vector MV_2 provided by the backward motion estimation 920 is added into the candidate sets CS_p and CS_f of the current block of the current frame. The projected motion estimation 930 uses the candidate set CS_p of the current block of the current frame to perform a third motion estimation operation (e.g. a projected motion estimation), so as to obtain a third motion vector (e.g. the motion vector MV_3) of the current block of the current frame. The motion vector MV_3 provided by the projected motion estimation 930 is added into the candidate sets CS_f and CS_b of the current block of the current frame. The motion estimation processes 910, 920 and 930 form an iterating chain that the motion vector obtained by a proceeding motion estimation serves to refine the candidate set of two subsequent motion estimation processes. That is, the motion vector MV_1 serves to refine the candidate sets CS_b and CS_p, the motion vector MV_2 serves to refine the candidate sets CS_p and CS_f, and the motion vector MV_3 serves to refine the candidate sets CS_f and CS_b.

Now, also refer to FIGS. 26 to 28, for generating the block B30 in the interpolation frame Fint, the forward motion estimation 910 is performed for the block B10 in frame F according to the candidate set CS_f which is refined by the projected motion vector MV_p″ from the projected motion estimation 930 of the block B60 located at the previously interpolated frame Fint′, and the backward motion vector MV_b′ from the backward motion estimation 920 for the block B10 of the frame F. Both MV_p″ and MV_b′ are motion vectors generated during the process of interpolating interpolation frame between the frames F−1 and F. According to the above mentioned refined candidate set CS_f, the forward motion estimation 910 generates the motion vector MV_f to refine the candidate sets CS_b and CS_p. Then the backward motion estimation 920 is performed for the block B40 in the frame F+1 to generate the motion vector MV_b. The motion vector MV_b is provided to refine the candidate sets CS_p and CS_f. Next, the projected motion estimation 930 is performed for the block B30 in the interpolation frame Fint to generate the projected motion vector MV_p. This motion vector MV_p is either qualified to be the final motion vector of the block B30 for generating pixel values of the block B30, or provided to refine the candidate sets CS_f and CS_b for another iteration of motion estimation processes starting from the forward motion estimation 910.

Although the arrangement of FIG. 34 has the forward motion estimation performed before the backward motion estimation prior to the projected motion estimation, it is possible to exchange the reference sequence of the forward motion estimation and the backward motion estimation, i.e. to have the backward motion estimation performed before the forward motion estimation prior to the projected motion estimation. Also, the sequence of forward and backward motion estimation processes can be exchanged in a reiterated process, i.e. with a sequence in first run and an exchanged sequence in second run.

To sum up, for interpolating the block B30 of the frame Fint from the frames F and F+1 in an FRC application, a forward motion estimation for the block B10 of the frame F and a backward motion estimation for the block B40 of the frame F+1 are arranged to provide candidate motion vectors of the candidate set of a projected motion estimation for the block B30. Further, the candidate motion vectors are refined along the way that respective motion estimation is performed in sequence. Furthermore, the motion estimation chain can be reiterated as the final motion vector of the projected motion estimation is not acceptable. This final motion vector is provided to the reiterated motion estimation for candidate set refinement so as to help convergence of the final target motion vector.

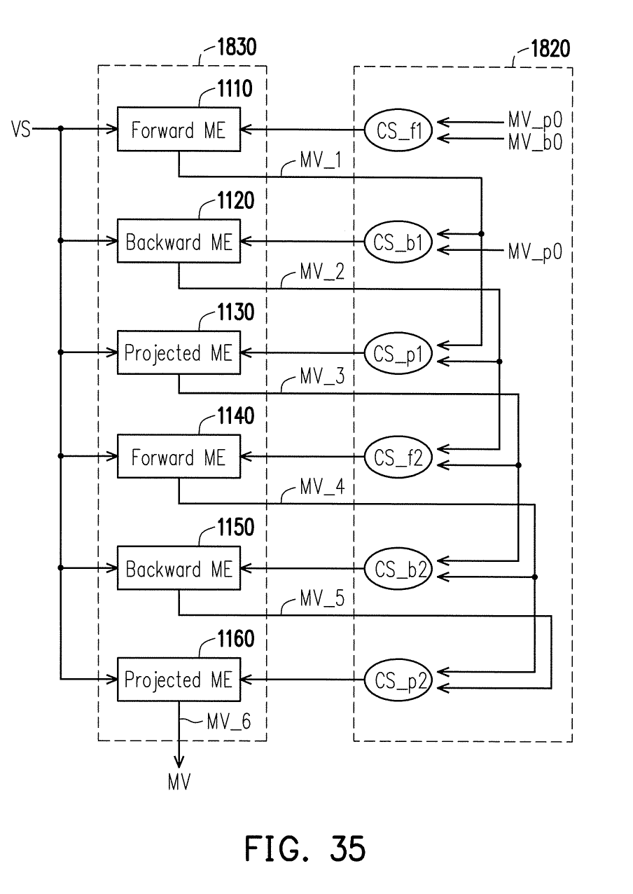

FIG. 35 is a schematic circuit block diagram showing the motion estimation apparatus 1800 depicted in FIG. 18 according to another exemplary embodiment of the invention, where an example of two iterations as that of FIG. 34 for obtaining the final target motion vector is shown. Referring to FIG. 35, the motion vector candidate set provided by the candidate set generation circuit 1820 includes a first motion vector candidate set (e.g. a candidate set CS_f1), a second motion vector candidate set (e.g. a candidate set CS_b1), a third motion vector candidate set (e.g. a candidate set CS_p1), a fourth motion vector candidate set (e.g. a candidate set CS_f2), a fifth motion vector candidate set (e.g. a candidate set CS_b2) and a sixth motion vector candidate set (e.g. a candidate set CS_p2), and the motion vector determination circuit 1830 includes a first motion estimator circuit (e.g. a forward motion estimation 1110), a second motion estimator circuit (e.g. a backward motion estimation 1120), a third motion estimator circuit (e.g. a projected motion estimation 1130), a fourth motion estimator circuit (e.g. a forward motion estimation 1140), a fifth motion estimator circuit (e.g. a backward motion estimation 1150) and a sixth motion estimator circuit (e.g. a projected motion estimation 1160). The circuits 1110 and 1140 are for the forward motion estimation in different searching directions, the circuits 1120 and 1150 are for the backward motion estimation in different searching directions, and the circuits 1130 and 1160 are for the projected motion estimation in different searching directions.

The forward motion estimation 1110 uses the candidate set CS_f1 of the current block of the current frame to perform a first motion estimation operation (e.g. a forward motion estimation), so as to obtain a first motion vector (e.g. the motion vector MV_1) of the current block of the current frame. The motion vector MV_1 provided by the forward motion estimation 1110 is added into the candidate sets CS_b1 and CS_p1 of the current block of the current frame. The backward motion estimation 1120 uses the candidate set CS_b1 of the current block of the current frame to perform a second motion estimation operation (e.g. a backward motion estimation), so as to obtain a second motion vector (e.g. the motion vector MV_2) of the current block of the current frame. The motion vector MV_2 provided by the backward motion estimation 1120 is added into the candidate sets CS_p1 and CS_f2 of the current block of the current frame. The projected motion estimation 1130 uses the candidate set CS_p1 of the current block of the current frame to perform a third motion estimation operation (e.g. a projected motion estimation), so as to obtain a third motion vector (e.g. the motion vector MV_3) of the current block of the current frame. The motion vector MV_3 provided by the projected motion estimation 1130 is added into the candidate sets CS_f2 and CS_b2 of the current block of the current frame. The forward motion estimation 1140 uses the candidate set CS_f2 of the current block of the current frame to perform a fourth motion estimation operation (e.g. a forward motion estimation), so as to obtain a fourth motion vector (e.g. the motion vector MV_4) of the current block of the current frame. The motion vector MV_4 provided by the forward motion estimation 1140 is added into the candidate sets CS_b2 and CS_p2 of the current block of the current frame. The backward motion estimation 1150 uses the candidate set CS_b1 of the current block of the current frame to perform a fifth motion estimation operation (e.g. a backward motion estimation), so as to obtain a fifth motion vector (e.g. the motion vector MV_5) of the current block of the current block current frame. The motion vector MV_5 provided by the backward motion estimation 1150 is added into the candidate set CS_p2 of the current block of the current frame. The projected motion estimation 1160 uses the candidate set CS_p2 of the current block of the current frame to perform a sixth motion estimation operation (e.g. a projected motion estimation), so as to obtain a sixth motion vector (e.g. the motion vector MV_6) of the current block of the current frame.

The candidate set CS_f1 is refined with a motion vector MV_b0 and a motion vector MV_p0 which both are from motion estimation processes for generating a previous interpolation frame. The candidate set CS_b1 is refined with the motion vector MV_p0 and a motion vector MV_1 from the forward motion estimation 1110. The candidate set CS_p1 is refined with the motion vector MV_1 from the forward motion estimation 1110 and a motion vector MV_2 from the backward motion estimation 1120. The candidate set CS_f2 is refined with the motion vector MV_2 from the backward motion estimation 1120 and a motion vector MV_3 from the projected motion estimation 1130. The candidate set CS_b2 is refined with the motion vector MV_3 from the projected motion estimation 1130 and a motion vector MV_4 from the forward motion estimation 1140. The candidate set CS_p2 is refined with the motion vector MV_4 from the forward motion estimation 1140 and a motion vector MV_5 from the backward motion estimation 1150. Finally, a final target motion vector MV_6 which is a projected motion vector refined over the projected motion vector MV_3 from the iterated motion estimation processes is obtained for making a corresponding interpolated block (i.e. current block Bc, e.g. the block B30 as shown in FIGS. 26 to 28) of an interpolation frame.

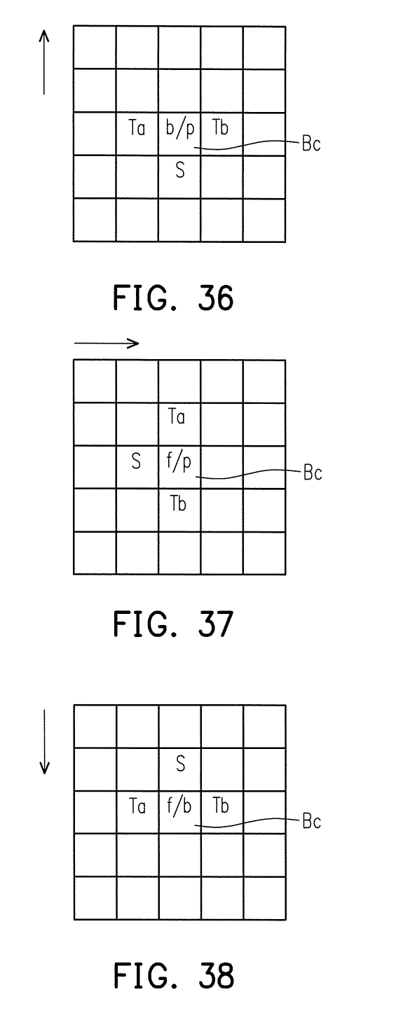

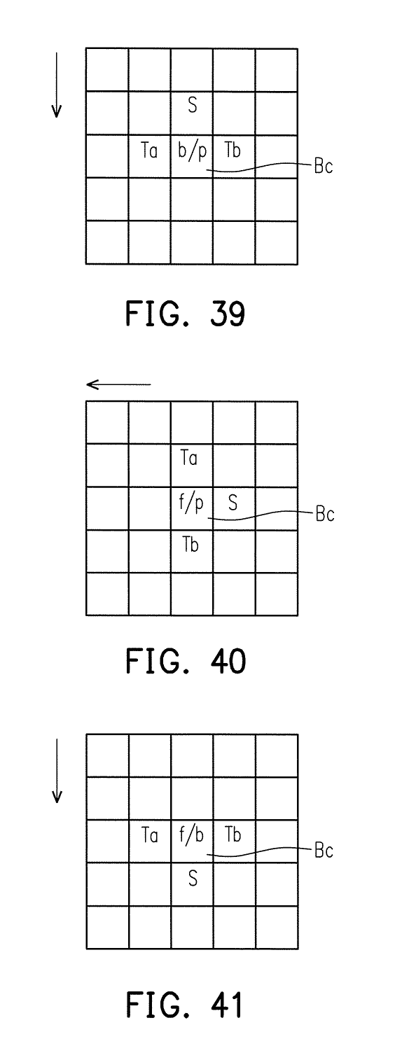

FIGS. 36 to 41 show a portion of the candidate sets CS_f1 to CS_p2 of FIG. 35 respectively. FIG. 36 shows a searching direction from bottom to top. Here, b/p at the current block Bc position correspond to the motion vectors MV_b0 and MV_p0 of FIG. 35, respectively. FIG. 37 shows a searching direction from left to right. Here, f/p at the current block Bc position correspond to the motion vector MV_1 from the forward motion estimation 1110 of FIG. 35 and the motion vector MV_p0 of FIG. 35 respectively. The embodiments of FIGS. 38 to 41 may be derived in the same way with reference to the descriptions related to the exemplary embodiments of FIGS. 36 to 37 and thus, will not be repeatedly described.

Referring to FIGS. 33 to 41, it is evident that for a current block Bc of a frame, a plurality of motion estimation processes are performed in sequence for blocks located at a same position as the current block Bc in adjacent frames, wherein each of the plurality of motion estimation processes has a motion vector generated in a preceding motion estimation served as candidate motion vector to refine the candidate set CS for subsequent motion estimation processes so as to refine a final target motion vector for the current block Bc. The final target motion vector can be provided to refine the candidate set CS for beginning motion estimation processes to restart the plurality of motion estimation processes so as to further refine the final target motion vector for the current block Bc. This reiteration of said plurality of motion estimation processes helps convergence of the final target motion vector. Each motion estimation process in the reiteration of the plurality of motion estimation processes may also alter the searching direction to incorporate new candidate motion vectors in order to refine its best matched motion vector, which in turn helps the convergence of the final target motion vector. This refinement approach for the candidate set CS and consequently target motion vector is particularly favorable to FRC applications. In an FRC application, the plurality of motion estimation processes involve forward motion estimation, backward motion estimation and projected motion estimation. A forward motion estimation and a backward motion estimation are performed prior to a projected motion estimation process. One of the forward motion estimation and the backward motion estimation is performed to generate a first motion vector to refine the candidate set CS of the other one of the forward motion estimation and the backward motion estimation. The later generates a second motion vector. The second motion vector, and maybe the first motion vector, are also provided to refine the candidate set CS of the projected motion estimation process. In such way, good convergence of final target motion vectors which are generated by the projected motion estimation process and are used for generating an interpolation frame between two original frames is achieved.

In some other exemplary embodiments, the candidate set CS_b1 may further include other candidate motion vectors. For example (but not limited to), a candidate motion vector of the candidate set CS_b1 may be a motion vector of an adjacent block (which is referred to as a first adjacent block) of the current block of the current frame. The first adjacent block and the current block Bc in the current frame belong to the same row (or the same column). Another candidate motion vector of the candidate set CS_b1 may be a motion vector of an adjacent block (which is referred to as a second adjacent block) in a previous frame. The second adjacent block in the previous frame and the current block Bc in the current frame belong to the same row (or the same column). Another candidate motion vector of the candidate set CS_b1 may be another motion vector of an adjacent block (which is referred to as a third adjacent block) in the previous frame. The third adjacent block in the previous frame and the current block Bc in the current frame belong to the same row or the same column. Another candidate motion vector of the candidate set CS_b1 may be the motion vector of the first adjacent block of the current block of the current frame plus a first random vector. The first random vector is obtained by randomly selecting a vector within a first vector range. Another candidate motion vector of the candidate set CS_b1 may be the motion vector of the first adjacent block of the current block of the current frame plus a second random vector. The second random vector is obtained by randomly selecting within a second vector range, and the second vector range is greater than the first vector range. The first and the second vector ranges may be determined based on design requirement. Another candidate motion vector of the candidate set CS_b1 may be a zero vector. Another candidate motion vector of the candidate set CS_b1 may be a global motion vector (GMV). Other candidate sets may be derived with reference to the description related to the candidate set CS_b1 and thus, will not be repeatedly described.

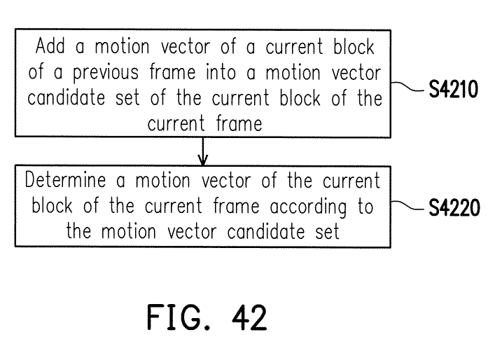

FIG. 42 is a flowchart showing a motion estimation method according to yet another exemplary embodiment of the invention. Please refer to FIGS. 18 and 42. In Step S4210, the candidate set generation circuit 1820 may select a block in the previous frame (which is at a position of the block is the same as the position of the current block Bc of the current frame, and thus, is referred to as a current block of the previous frame). A motion vector of the current block of the previous frame is added to the motion vector candidate set CS of the current block Bc of the current frame. The motion vector determination circuit 1830 is coupled to the candidate set generation circuit 1820 to receive the motion vector candidate set. In Step S4220, the motion vector determination circuit 1830 may determine a motion vector of the current block of the current frame according to the motion vector candidate set. Please refer to the descriptions related to FIGS. 29 to 31 for implementation examples of steps S4210 and S4220 in detail.

Based on the above, different motion estimator circuits are introduced to the apparatus and the method for motion estimation of the exemplary embodiments of the invention. The motion vector candidate sets used by the motion estimator circuits are different from those used in the 3DRS technique of the related art, such that the motion estimation apparatus of the invention has a faster convergence speed and predicted motion vectors with better accuracy.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A motion estimation method for estimating motion vectors of blocks of a current frame, comprising:
selecting to add motion vectors of a plurality of adjacent blocks into a motion vector candidate set of a current block of the current frame, wherein the current block and one of the adjacent blocks belong to the same row or the same column, and the one of the adjacent blocks is a block of the current frame or a block of a previous frame; and
determining a motion vector of the current block of the current frame according to the motion vector candidate set.

2. The motion estimation method according to claim 1, wherein the motion vector candidate set comprises a first motion vector candidate set and a second motion vector candidate set, and the step of determining the motion vector of the current block of the current frame according to the motion vector candidate set comprises:
performing a first motion estimation operation according to the first motion vector candidate set of the current block of the current frame by a first motion estimator circuit, so as to obtain a first motion vector of the current block of the current frame;
adding the first motion vector provided by the first motion estimator circuit into the second motion vector candidate set of the current block of the current frame; and
performing a second motion estimation operation according to the second motion vector candidate set of the current block of the current frame by a second motion estimator circuit, so as to obtain a second motion vector of the current block of the current frame.

3. The motion estimation method according to claim 2, wherein the motion vector candidate set further comprises a third motion vector candidate set, and the step of determining the motion vector of the current block of the current frame according to the motion vector candidate set further comprises:
adding the second motion vector provided by the second motion estimator circuit into the third motion vector candidate set of the current block of the current frame; and
performing a third motion estimation operation according to the third motion vector candidate set of the current block of the current frame by a third motion estimator circuit, so as to obtain a third motion vector of the current block of the current frame.

4. The motion estimation method according to claim 3, wherein the step of determining the motion vector of the current block of the current frame according to the motion vector candidate set further comprises:
adding the first motion vector provided by the first motion estimator circuit into the third motion vector candidate set of the current block of the current frame.

5. The motion estimation method according to claim 3, wherein the step of determining the motion vector of the current block of the current frame according to the motion vector candidate set further comprises:
adding the second motion vector provided by the second motion estimator circuit into the first motion vector candidate set of the current block of the current frame.

6. The motion estimation method according to claim 3, wherein the step of determining the motion vector of the current block of the current frame according to the motion vector candidate set further comprises:
adding the third motion vector provided by the third motion estimator circuit into the first motion vector candidate set of the current block of the current frame.

7. The motion estimation method according to claim 3, wherein the step of determining the motion vector of the current block of the current frame according to the motion vector candidate set further comprises:
adding the third motion vector provided by the third motion estimator circuit into the second motion vector candidate set of the current block of the current frame.

8. The motion estimation method according to claim 3, wherein the motion vector candidate set further comprises a fourth motion vector candidate set, a fifth motion vector candidate set and a sixth motion vector candidate set, and the step of determining the motion vector of the current block of the current frame according to the motion vector candidate set further comprises:
adding the third motion vector provided by the third motion estimator circuit into the fourth motion vector candidate set of the current block of the current frame;
performing a fourth motion estimation operation according to the fourth motion vector candidate set of the current block of the current frame by a fourth motion estimator circuit, so as to obtain a fourth motion vector of the current block of the current frame;
adding the fourth motion vector provided by the fourth motion estimator circuit into the fifth motion vector candidate set of the current block of the current frame;
performing a fifth motion estimation operation according to the fifth motion vector candidate set of the current block of the current frame by a fifth motion estimator circuit, so as to obtain a fifth motion vector of the current block of the current frame;
adding the fifth motion vector provided by the fifth motion estimator circuit into the sixth motion vector candidate set of the current block of the current frame; and
performing a sixth motion estimation operation according to the sixth motion vector candidate set of the current block of the current frame by a sixth motion estimator circuit, so as to obtain a sixth motion vector of the current block of the current frame.

9. The motion estimation method according to claim 2, wherein the second motion vector candidate set of the current block of the current frame comprises:
the first motion vector of the current block of the current frame which is provided by the first motion estimator circuit;
a motion vector of a first adjacent block of the current block of the current frame, wherein the first adjacent block and the current block belong to the same row or the same column; and
a motion vector of a second adjacent block in the previous frame, wherein the second adjacent block and the current block belong to the same row or the same column.

10. The motion estimation method according to claim 9, wherein the second motion vector candidate set of the current block of the current frame further comprises:
a motion vector of a third adjacent block in the previous frame, wherein the third adjacent block and the current block belong to the same row or the same column;
the motion vector of the first adjacent block of the current block of the current frame plus a first random vector, wherein the first random vector is obtained by randomly selecting a vector from a first vector range;
the motion vector of the first adjacent block of the current block of the current frame plus a second random vector, wherein the second random vector is obtained by randomly selecting a vector from a second vector range, and the second vector range is greater than the first vector range; and
a zero vector or a global motion vector.

11. A motion estimation apparatus for estimating motion vectors of blocks of a current frame, comprising:
a candidate set generation circuit, configured to select to add motion vectors of a plurality of adjacent blocks into a motion vector candidate set of a current block of the current frame, wherein the current block and one of the adjacent blocks belong to the same row or the same column, and the one of the adjacent blocks is a block of the current frame or a block of a previous frame; and
a motion vector determination circuit, coupled to the candidate set generation circuit to receive the motion vector candidate set, and configured to determine a motion vector of the current block of the current frame according to the motion vector candidate set.

12. The motion estimation apparatus according to claim 11, wherein the motion vector candidate set comprises a first motion vector candidate set and a second motion vector candidate set, and the motion vector determination circuit comprises:
a first motion estimator circuit, performing a first motion estimation operation according to the first motion vector candidate set of the current block of the current frame, so as to obtain a first motion vector of the current block of the current frame, wherein the candidate set generation circuit adds the first motion vector provided by the first motion estimator circuit into the second motion vector candidate set of the current block of the current frame; and
a second motion estimator circuit, performing a second motion estimation operation according to the second motion vector candidate set of the current block of the current frame, so as to obtain a second motion vector of the current block of the current frame.

13. The motion estimation apparatus according to claim 12, wherein the motion vector candidate set further comprises a third motion vector candidate set, the candidate set generation circuit adds the second motion vector provided by the second motion estimator circuit into the third motion vector candidate set of the current block of the current frame, and the motion vector determination circuit further comprises:
a third motion estimator circuit, performing a third motion estimation operation according to the third motion vector candidate set of the current block of the current frame, so as to obtain a third motion vector of the current block of the current frame.

14. The motion estimation apparatus according to claim 13, wherein the candidate set generation circuit adds the first motion vector provided by the first motion estimator circuit into the third motion vector candidate set of the current block of the current frame.

15. The motion estimation apparatus according to claim 13, wherein the candidate set generation circuit adds the second motion vector provided by the second motion estimator circuit into the first motion vector candidate set of the current block of the current frame.

16. The motion estimation apparatus according to claim 13, wherein the candidate set generation circuit adds the third motion vector provided by the third motion estimator circuit into the first motion vector candidate set of the current block of the current frame.

17. The motion estimation apparatus according to claim 13, wherein the candidate set generation circuit adds the third motion vector provided by the third motion estimator circuit into the second motion vector candidate set of the current block of the current frame.

18. The motion estimation apparatus according to claim 13, wherein the motion vector candidate set further comprises a fourth motion vector candidate set, a fifth motion vector candidate set and a sixth motion vector candidate set, the candidate set generation circuit adds the third motion vector provided by the third motion estimator circuit into the fourth motion vector candidate set of the current block of the current frame, and the motion vector determination circuit further comprises:
a fourth motion estimator circuit, performing a fourth motion estimation operation according to the fourth motion vector candidate set of the current block of the current frame, so as to obtain a fourth motion vector of the current block of the current frame, wherein the candidate set generation circuit adds the fourth motion vector provided by the fourth motion estimator circuit into the fifth motion vector candidate set of the current block of the current frame;
a fifth motion estimator circuit, performing a fifth motion estimation operation by using the fifth motion vector candidate set of the current block of the current frame, so as to obtain a fifth motion vector of the current block of the current frame, wherein the candidate set generation circuit adds the fifth motion vector provided by the fifth motion estimator circuit into the sixth motion vector candidate set of the current block of the current frame; and
a sixth motion estimator circuit, performing a sixth motion estimation operation according to the sixth motion vector candidate set of the current block of the current frame, so as to obtain a sixth motion vector of the current block of the current frame.

19. The motion estimation apparatus according to claim 12, wherein the second motion vector candidate set of the current block of the current frame comprises:
the first motion vector of the current block of the current frame which is provided by the first motion estimator circuit;
a motion vector of a first adjacent block of the current block of the current frame, wherein the first adjacent block and the current block belong to the same row or the same column; and
a motion vector of a second adjacent block in the previous frame, wherein the second adjacent block and the current block belong to the same row or the same column.

20. The motion estimation apparatus according to claim 19, wherein the second motion vector candidate set of the current block of the current frame further comprises:
a motion vector of a third adjacent block in the previous frame, wherein the third adjacent block and the current block belong to the same row or the same column;
the motion vector of the first adjacent block of the current block of the current frame plus a first random vector, wherein the first random vector is obtained by randomly selecting a vector from a first vector range;
the motion vector of the first adjacent block of the current block of the current frame plus a second random vector, wherein the second random vector is obtained by randomly selecting a vector from a second vector range, and the second vector range is greater than the first vector range; and
a zero vector or a global motion vector.

21. A motion estimation method for estimating motion vectors of blocks of a current frame, comprising:
selecting to add a motion vector of a current block of a previous frame into a motion vector candidate set of the current block of the current frame; and
determining a motion vector of the current block of the current frame according to the motion vector candidate set.

22. A motion estimation apparatus for estimating motion vectors of blocks of a current frame, comprising:
a candidate set generation circuit, configured to select to add a motion vector of a current block of a previous frame into a motion vector candidate set of the current block of the current frame; and
a motion vector determination circuit, coupled to the candidate set generation circuit to receive the motion vector candidate set, and configured to determine motion vector of the current block of the current frame according to the motion vector candidate set.
